(19) United States
(12) Patent Application Publication
(10) Pub. No.: US 2024/0034665 A1
(43) Pub. Date: Feb. 1, 2024

(54) Soot-Free Production Process of Preforms for Structured Fibers

(71) Applicant: Heraeus Quarzglas GmbH & Co. KG, HANAU (DE)

(72) Inventors: Manuel ROSENBERGER, Hanau (DE); Jaqueline PLASS, Hanau (DE); Yusuf TANSEL, Hanau (DE); Benjamin REIS, Hanau (DE); Enrico EHRENTRAUT, Hanau (DE)

(21) Appl. No.: 18/255,956

(22) PCT Filed: Nov. 19, 2021
(86) PCT No.: PCT/EP2021/082308

§ 371 Date: Jun. 5, 2023

(30) Foreign Application Priority Data
Dec. 9, 2020 (EP) 20212771.8

(51) Int. Cl. C03B 37/012

(52) U.S. Cl. CPC C03B 37/01211; C03B 2203/16

(57) ABSTRACT

A method for producing a preform of an anti-resonant hollow-core fiber, comprising the steps of
a) providing a cladding tube, which has a cladding tube inner bore and a cladding tube longitudinal axis, along which a cladding tube wall extends, which is limited by an inner side and an outer side,
b) preparing a number of anti-resonance element preforms, each comprising an ARE outer tube and an ARE inner tube inserted therein,
c) preparing a positioning template, having a number of passage openings passing through the positioning template, adapted for a longitudinal guidance of an anti-resonance element preform each, wherein the positioning template and the cladding tube are made of identical material,
d) attaching the positioning template to a first end of the cladding tube,
e) inserting at least parts of the anti-resonance element preforms through the passage openings.

### BACKGROUND OF THE INVENTION

The invention relates to a method for producing a preform of an anti-resonant hollow-core fiber.

### Prior Art

Hollow-core fibers have a core, which comprises an evacuated cavity, which is filled with gas or liquid. In hollow-core fibers, the interaction of the light with the glass is smaller than in solid core fibers. The refractive index of the core is smaller than that of the cladding, so that a light guidance by means of total reflection is not possible.

Depending on the physical mechanism of the light guidance, hollow-core fibers are divided into photonic bandgap fibers” and “anti-resonance reflection fibers”.

In the case of “photonic bandgap fibers”, the hollow core region is surrounded by a cladding, in which small hollow ducts are arranged periodically. The periodic structure in the cladding causes the effect, which, with reference to the semiconductor technology, is referred to as “photonic bandgap”, according to which light of certain wavelength ranges scattered at the cladding structures interferes constructively due to Bragg reflection in the central cavity, and cannot propagate transversely in the cladding.

In the case of the embodiment of the hollow-core fiber, which is referred to as “anti-resonant hollow-core fiber” (ARHCF), the hollow core region is surrounded by an inner cladding region, in which so-called anti-resonance elements (also “anti-resonant elements” or also “AREs”) are arranged. The walls of the anti-resonance elements, which are evenly distributed around the hollow core, can act as Fabry-Perot cavities, which are operated in anti-resonance and which reflect the incident light and guide it through the fiber core.

This fiber technology promises a low optical attenuation, a very broad transmission spectrum (also in the UV or IR wavelength range), and a small latency during the data transmission.

An anti-resonant hollow-core fiber is known from EP 3 136 143 A1 (referred to therein as “hollow-core fiber without bandgap”), in the case of which the core can also guide further modes, in addition to the fundamental mode. For this purpose, the core is surrounded by an inner cladding comprising “non-resonant elements”, which provide a phase adaptation of anti-resonant modes with the higher modes.

A method for producing a preform for anti-resonant hollow-core fibers is known from JP 2018 150184 A, in the case of which the use of welded-on perforated disks at the cladding tube ends for positioning the non-resonant elements is shown. It turned out to be disadvantageous thereby that the required positioning accuracy of the non-resonant elements (ARE) is not attained with this type of perforated disks.

Further methods for connecting the ARE and the cladding tube are described in the following documents: CN 105807363 B, WO 2015 185761 A1, WO 2017 108061 A1, WO 2018 169487 A1.

### Technical Object

Anti-resonant hollow-core fibers and in particular those comprising nested structural elements have complex inner geometries, which makes their exact and reproducible production more difficult. This applies all the more, because only dimensional deviations below the magnitude of the working wavelength of the light to be guided can be tolerated in order to adhere to the resonance or anti-resonance conditions, respectively. The configuration of the fiber preform can be the cause of deviations from the target geometry, and they can also occur due to unwanted deformations, which are not to scale, during the fiber drawing process.

It is the goal of the invention to specify a method for the cost-efficient production of a preform for an anti-resonant hollow-core fiber, which avoids limitations of conventional production methods.

It is in particular the goal of the invention to provide a method for producing a preform for anti-resonant hollow-core fibers, by means of which an exact positioning of the anti-resonance elements can be reproducibly attained in a sufficiently stable manner.

### PREFERRED EMBODIMENTS OF THE INVENTION

The features of the independent claims make a contribution to at least partially fulfilling at least one of the above-mentioned objects. The dependent claims provide preferred embodiments, which contribute to at least partially fulfilling at least one of the objects.
/1./ A method for producing a preform of an anti-resonant hollow-core fiber, comprising the steps of
   a) providing a cladding tube, which has a cladding tube inner bore and a cladding tube longitudinal axis, along which a cladding tube wall extends, which is limited by an inner side and an outer side,
   b) preparing a number of anti-resonance element preforms, each comprising an ARE outer tube and an ARE inner tube inserted therein,
   c) preparing a positioning template, having a number of passage openings passing through the positioning template, adapted for a longitudinal guidance of an anti-resonance element preform each, wherein the positioning template and the cladding tube are made of identical material,
   d) attaching the positioning template to a first end of the cladding tube,
   e) inserting at least parts of the anti-resonance element preforms through the passage openings for arranging the anti-resonance element preforms in the cladding tube inner bore,
   f) processing an assembly, comprising the cladding tube, the anti-resonance element preforms, and the positioning template, by means of a hot-forming process, selected from at least one of elongating and collapsing,
   characterized in that
   the positioning template has at least one centering surface, which cooperates with the first end of the cladding tube in a self-centering manner in such a way that the anti-resonance element preforms are arranged at target positions in step e) “inserting”.
/2./ The method according to embodiment 1, characterized in that the cladding tube is at least partially cut out in the region of the first end in order to form a counter centering surface, which cooperates with the centering surface in a positive manner.
/3./ The method according to any one of the preceding embodiments, characterized in that the positioning template is at least partially shaped in a truncated cone-like manner, wherein the centering surface is at least partially formed in a cladding surface-like manner.
/4./ The method according to any one of the preceding embodiments, characterized in that the cladding tube is cut out at least partially in a truncated cone-like manner in the region of the first end.
/5./ The method according to any one of the preceding embodiments, characterized in that the anti-resonance element preforms are thermally fixed in a flame-free manner to the cladding tube wall in step f) “processing”.
/6./ The method according to any one of the preceding embodiments, characterized in that the cladding tube has a second end.
/7./ The method according to embodiment 6, characterized in that the method comprises the steps of:
   (i) creating a second positioning template, having a number of second passage openings passing through the second positioning template, adapted for a longitudinal guidance of an anti-resonance element preform each, wherein the second positioning template and the cladding tube are made of identical material,
   (ii) combining the second positioning template with the second end of the cladding tube.
/8./ The method according to embodiment 7, characterized in that the method comprises the steps of
   (iii) inserting at least parts of the anti-resonance element preforms through the second passage openings of the second positioning template,
   (iv) wherein the second positioning template has at least one second centering surface, which cooperates with the second end of the cladding tube in a self-centering manner in such a way that the anti-resonance element preforms are arranged at target positions in step (iii) “inserting”.
/9./ The method according to embodiment 8, characterized in that the cladding tube is at least partially cut out in the region of the second end in order to form a second counter centering surface, which cooperates with the second centering surface in a positive manner.
/10./ The method according to any one of the preceding embodiments 7 to 9, characterized in that the second positioning template is at least partially shaped in a truncated cone-like manner, wherein the second centering surface is at least partially formed in a cladding surface-like manner.
/11./ The method according to any one of the preceding embodiments 6 to 10, characterized in that the cladding tube is at least partially cut out in a truncated cone-like manner in the region of the second end.
/12./ The method according to any one of the preceding embodiments, characterized in that the method comprises the step of:
   A/ preparing a third positioning template, having a number of third passage openings passing through the third positioning template, adapted for a longitudinal guidance of an anti-resonance element preform each,
      wherein the third positioning template has at least one third centering surface.
/13./ The method according to embodiment 12, characterized in that the method comprises the step of:
   B/ producing a tubular closing element,
      wherein the closing element has an active surface in the region of a first end region in order to cooperate with the third centering surface, in particular to cooperate in a positive manner.
/14./ The method according to embodiment 13, characterized in that the method comprises the steps of:
   C/ linking the third positioning template to the first end region,
   D/ connecting the closing element to the second end of the cladding tube,
   E/ pushing at least parts of the anti-resonance element preforms through the third passage openings in order to arrange the anti-resonance element preforms in the cladding tube inner bore, wherein the third centering surface cooperates with the active surface in a self-centering manner in such a way that the anti-resonance element preforms are arranged at target positions.
/15./ The method according to any one of the preceding embodiments, characterized in that at least one of the following steps comprises a flame-free thermal connecting or a flame-based thermal connecting:
   step b) “preparing”,
   step d) “attaching”,
   step (ii) “combining”,
   step C/ “linking”, and
   step D/ “connecting”.
/16./ The method according to any one of the preceding embodiments, characterized in that the method comprises at least one of the steps:
   thermal fixing, in particular flame-free thermal fixing, of at least some of the anti-resonance element preforms to the positioning template, and/or
   thermal fixing, in particular flame-free thermal fixing, of at least some of the anti-resonance element preforms to the second positioning template, and/or,
   thermal fixing, in particular flame-free thermal fixing, of at least some of the anti-resonance element preforms to the third positioning template.
/17./ The method according to any one of the preceding embodiments, characterized in that prior to step f) “processing”, the anti-resonance element preforms are only held by means of
   the positioning template, or
   the positioning template and the second positioning template, or
   the positioning template and the third positioning template
   and otherwise without a substance-to-substance bond in the cladding tube inner bore.
/18./ The method according to any one of the preceding embodiments, characterized in that, in some regions, preferably at a first ARE end, the ARE outer tube has a widening of the outer diameter, which is larger than an inner diameter of at least one of the passage openings, the second passage openings, and the third passage openings.
/19./ The method according to any one of the preceding embodiments, characterized in that, in some regions, preferably at a second ARE end, the ARE outer tube has a tapering of the outer diameter, which is smaller than an inner diameter of at least one of the passage openings, the second passage openings, and the third passage openings.
/20./ The method according to any one of the preceding embodiments, characterized in that the positioning template and/or the second positioning template and/or the third positioning template has at least one gas flow element, which connects the cladding tube inner bore to the surrounding area of the preform in a fluid-conducting manner.
/21./ The method according to any one of the preceding embodiments, characterized in that the cladding tube inner bore is created by means of machining, in particular by means of drilling, milling, grinding, honing, and/or polishing.
/22./ The method according to any one of the preceding embodiments, characterized in that the cladding tube has an outer diameter in the range of 65 to 300 mm, in particular 90 to 250 mm, and in particular has a length of at least 1 m.
/23./ A method for producing a secondary preform, from which an anti-resonant hollow-core fiber can be drawn, from a preform, produced according to any one of the preceding embodiments 1 to 22, having the step of
   further processing the preform into the secondary preform,
wherein the further processing comprises a one-time or repeated performance of one or several of the following hot-forming processes:
   i.) elongating,
   ii.) collapsing,
   iii.) collapsing and simultaneous elongating,
   iv.) adding additional cladding material,
   v.) adding additional cladding material and subsequent elongating,
   vi.) adding additional cladding material and simultaneous elongating.
/24./ A method for producing an anti-resonant hollow-core fiber from a preform, produced according to any one of the preceding embodiments 1 to 22, having the step of
   further processing the preform into the anti-resonant hollow-core fiber, wherein the further processing comprises a one-time or repeated performance of one or several of the following hot-forming processes:
   i.) elongating,
   ii.) collapsing,
   iii.) collapsing and simultaneous elongating,
   iv.) adding additional cladding material,
   v.) adding additional cladding material and subsequent elongating,
   vi.) adding additional cladding material and simultaneous elongating.
/25./ The method according to any one of the preceding embodiments, characterized in that a relative inner pressure in the range of between −25 to −300 mbar, in particular −100 to −250 mbar, is set in step f) “processing” as part of the elongating and/or collapsing in the cladding tube inner bore.

Some of the described features are linked with the term “essentially”. The term “essentially” is to be understood in such a way that under real conditions and manufacturing techniques, a mathematically exact interpretation of terms, such as “overlapping” “perpendicular”, “diameter”, or “parallelism” can never be provided exactly, but only within certain manufacturing-related error tolerances. For example, “essentially parallel axes” draw an angle of −5 degrees to 5 degrees to one another, and “essentially identical volumes” comprise a deviation of up to 5% by volume. A “device essentially consisting of quartz glass” comprises, for example, a quartz glass portion of ≥95 to ≤100% by weight. Furthermore, “essentially at a right angle” includes an angle of 85 degrees to 95 degrees.

### DETAILED DESCRIPTION

The invention relates to a method for producing a preform of an anti-resonant hollow-core fiber, comprising the steps of:
a) providing a cladding tube, which has a cladding tube inner bore and a cladding tube longitudinal axis, along which a cladding tube wall extends, which is limited by an inner side and an outer side,
b) preparing a number of anti-resonance element preforms, each comprising an ARE outer tube and an ARE inner tube inserted therein,
c) preparing a positioning template, having a number of passage openings passing through the positioning template, adapted for a longitudinal guidance of an anti-resonance element preform each, wherein the positioning template and the cladding tube are made of identical material,
d) attaching the positioning template to a first end of the cladding tube,
e) inserting at least parts of the anti-resonance element preforms through the passage openings for arranging the anti-resonance element preforms in the cladding tube inner bore,
f) processing an assembly, comprising the cladding tube, the anti-resonance element preforms, and the positioning template, by means of a hot-forming process, selected from at least one of elongating and collapsing.

To overcome the above-mentioned disadvantages in the prior art, it is provided according to the invention that the positioning template has at least one centering surface, which cooperates with the first end of the cladding tube in a self-centering manner in such a way that the anti-resonance element preforms are arranged at target positions in step e) “inserting”.

With the use of the positioning template, the method for producing the preform provides for a reproducible and precise arrangement of the anti-resonance element preforms in the cladding tube inner bore. The preform is thereby that component, from which the anti-resonant hollow-core fiber can be drawn. In the alternative, the preform can be further processed into a secondary preform, from which the hollow-core fiber is drawn. The method thereby comprises the following steps:

Step a)

The cladding tube is prepared as part of step a) “providing”. This cladding tube has a hollow core, which extends along the cladding tube longitudinal axis. In an embodiment, the cladding tube has an outer diameter in the range of 65 to 300 mm, preferably 90 to 250 mm, preferably 120 to 200. The cladding tube can in particular have a length of at least 1 m. In an embodiment, the cladding tube comprises or consists of a material, which is transparent for a work light of the optical fiber, for example, glass, in particular doped or undoped quartz glass (SiO2). A doping provides for the adaptation of physical properties, such as, for example, the thermal expansion coefficient. Fluorine, chlorine and/or hydroxyl groups are preferably used as doping agents, which lower the viscosity of quartz glass.

Step b)

A number of anti-resonance element preforms are created as part of step b) “preparing”. Components or components parts of the preform, which essentially turn into anti-resonance elements in the hollow-core fiber by means of simple stretching during the fiber drawing process, are referred to as anti-resonance element preforms. The individual anti-resonance element preform is constructed of tubular structural elements, at least a part of which can have a wall thickness in the range of 0.1 mm to 2 mm, preferably 0.2 mm to 1.5 mm. The anti-resonance element preforms can be simple or nested components, wherein the respective anti-resonance element preform comprises an ARE outer tube and an ARE inner tube inserted therein. The anti-resonance element preforms have at least two walls, which, viewed from the direction of the hollow core, have a negative curvature (convex) or no curvature (flat, straight). By further processing the preform, in particular by means of hot-forming steps, intermediate products can be created, in which the original anti-resonance element preforms are present in a shape, which is changed compared to the original shape.

In an embodiment, the anti-resonance element preform comprises or consists of a material, which is transparent for a work light of the optical fiber, for example glass, in particular doped or undoped quartz glass (SiO2). A doping provides for the adaptation of physical properties, such as, for example, the thermal expansion coefficient. Fluorine, chlorine and/or hydroxyl groups are preferably used as doping agents, which lower the viscosity of quartz glass.

In an embodiment, the anti-resonance element preforms and the cladding tube are made of identical material. In a further embodiment, the anti-resonance element preforms and the cladding tube consist of the same material, in particular of undoped or doped quartz glass (SiO2), wherein the amount of the doping does not exceed 0.1% by weight.

The term made of identical material describes the substance property of two parts. The two parts thereby have essentially the same chemical substance. The total mass of the different chemical elements in both parts can thereby be less than 1% by weight, in particular less than 0.5% by weight, in particular less than 0.1% by weight. The chemical composition of the two parts in particular differs by a content of contaminations of less than 500 ppm by weight, in particular less than 100 ppm by weight, and/or by a content of doping agent of less than 10000 ppm by weight, in particular less than 5000 ppm by weight.

Step c)

As part of step c) “preparing”, the positioning template is created. The positioning template has a cylindrical, cover-like, or disk-like shape. In an embodiment, the positioning template has a transversal extension of 5 to 200 mm, in particular 15 to 80 mm. In an embodiment, the positioning template and the cladding tube consist of the same material, in particular of undoped or doped quartz glass (SiO2), wherein the amount of the doping does not exceed 0.1% by weight.

The positioning template has a number of passage openings, which pass through the positioning template. Each passage opening is set up in such a way so as to establish at least one fluid-conducting connection between the cladding tube inner bore and an outer space through a base body of the positioning template. The inner diameter of the passage opening is furthermore designed in such a way that an anti-resonance element preform can largely be pushed through longitudinally. This statement does not limit the one use of a widening of the ARE outer tube, which serves for the positioning of the anti-resonance element preforms and which will be described in more detail later.

The passage openings are furthermore adapted for a longitudinal guidance of an anti-resonance element preform each. The passage openings support the anti-resonance element preforms in step f) “processing”, so that the design thereof can influence the accuracy during the positioning of the anti-resonance element preforms in the cladding tube inner bore. To attain the desired accuracy during the positioning of the anti-resonance element preforms at target positions, the passage openings can have one or several of the following features:
The difference between the inner diameter of the passage opening and the outer diameter of the anti-resonance element preforms can be less than 5% of the outer diameter of the anti-resonance element preforms, in particular less than 3.5%, preferably less than 2%.
At least 95%, preferably at least 97%, preferably at least 99.7% of the surface of the passage opening have a roughness Ra of [0.01; 0.4] μm, preferably [0.02; 0.2] μm.
The surface of the passage opening has fewer than 1000 micro cracks/cm2, preferably fewer than 500 micro cracks/cm2.

In an embodiment, the positioning template and the cladding tube consist of the same material, in particular of undoped or doped quartz glass (SiO2), wherein the amount of the doping does not exceed 0.1% by weight.

The positioning template and the cladding tube are made of identical material. The above-defined term made of identical material describes the substance property of the two-parts positioning template and cladding tube.

Step d)

As part of step d) “attaching”, the positioning template we connected to the first end of the cladding tube. In the method according to the invention, the positioning template serves the purpose of positioning the anti-resonance element preforms in the cladding tube inner bore. In order to do so, a bond is required between positioning template and the cladding tube.

Step e)

As part of step d) “inserting”, an at least partial inserting of the anti-resonance element preforms through the passage openings takes place. It is the goal thereby that the anti-resonance element preforms are arranged in the cladding tube inner bore.

Step f)

As part of step d) “processing”, the assembly comprising the cladding tube, the anti-resonance element preforms, and the positioning template is further processed by means of at least one of the hot processes elongating and collaborating.

In the context of the invention, the term of an elongating is understood to be an enlargement of the longitudinal expansion of a body. This enlargement of the longitudinal expansion can be associated with a reduction of the transversal expansion of the body. The elongating can take place to scale, so that, for example, the shape and arrangement of components or component parts are reflected in the elongated end product.

In the context of the invention, the term of a collapsing is understood to be a reduction of the transversal expansion of a body. This reduction of the transversal expansion of the body can take place as part of an increase of the temperature of the body, and can in particular lead to an enlargement of the longitudinal expansion of the body.

The term hot process is understood to be a method step, during which the temperature of an element is increased by means of heat input. Examples for hot processes are:
Flame-based hot processes based on the oxidation of an exothermically reacting gas. One example is the use of hydrogen—also referred to as “H2”— as combustion gas (the flame hydrolysis). It reacts with the oxygen—also referred to as “O2”— in the air.
Flame-free hot processes use other systems, which warm up and which do not require an open flame. One example is the use of a resistor, which converts electrical energy into thermal energy (heat).

According to the invention, it is provided that the positioning template has at least one centering surface. This centering surface cooperates with the first end of the cladding tube in a self-centering manner in such a way that the anti-resonance element preforms are arranged at target positions in step e) “inserting”.

In the context of the invention, the term self-centering describes a cooperation of two bodies, which have an outer shape, which is designed in such a way that both assume a predefined position to one another without external influences.

The fulfillment of at least one of the following conditions is essential for adhering to the resonance or anti-resonance conditions, respectively, in the later hollow-core fiber, or for a further reduction of the attenuation in the later hollow-core fiber:
The anti-resonance element performs have to be arranged at the pre-calculated target positions in the cladding tube.
The anti-resonance element preforms have to be arranged at the pre-calculated target positions in the assembly.
The anti-resonance element preforms have to be arranged the pre-calculated target positions in the preform.

The invention provides for a reduction of the deviation of the actual position of the anti-resonance element preforms from the target position in the cladding tube and/or the assembly and/or the preform.

To achieve this reduction, the positioning template has at least the centering surface, which, due to the self-centering, achieves a reproducible positioning with respect to the cladding tube and—derived therefrom—a reproducible positioning of the passage openings with respect to the cladding tube inner bore. The latter then leads to a reproducible positioning of the anti-resonance element preforms at the target positions in the cladding tube and/or the assembly and/or the preform.

After step d) “attaching”, a longitudinal axis of the passage opening can be aligned essentially parallel to the longitudinal axis of the cladding tube longitudinal axis. In an embodiment, the longitudinal axis of the passage opening and the cladding tube longitudinal axis is designed parallel in such a way that after step d) “attaching” and step e) “inserting”, the longitudinal axis of the anti-resonance element preforms and the cladding tube longitudinal axis have an angle of −1.5 degrees to 1.5 degrees, preferably of −0.85 degrees to 0.85 degrees, preferably of −0.42 degrees to 0.42 degrees to one another. This parallelism ensures that the anti-resonance element preforms are arranged at the target positions in the cladding tube and/or the assembly and/or the preform, and thus ensures that the resonance or anti-resonance conditions, respectively, are adhered to in the later hollow-core fiber.

The positioning template can in particular have a first positioning element, such as a cut-out, which cooperates with a first counter positioning element at the first end of the cladding tube, and thus prevents a rotation of the positioning template around its longitudinal axis in this way.

As part of an embodiment, the positioning template can have at least one cylindrically designed passage opening. The inner diameter of the at least one passage opening thereby has a diameter, which is 0.15% to 7%, in particular 0.35% to 6%, in particular 0.55% to 3.5% larger than the outer diameter of the anti-resonance element preforms. In the case of this type of design, the anti-resonance element preforms can be pushed directly through the passage opening, and can come to rest in a positive and/or non-positive manner against the inner wall of the passage openings, in particular over the entire length of the positioning template.

An embodiment is characterized in that in the region of the first end, the cladding tube is at least partially cut out in order to form a counter centering surface, which cooperates with the centering surface in a positive manner. This type of cooperation facilitates the self-centering cooperation of the centering surface and the first end of the cladding tube, and can occur in particular as part of step e) “inserting”. The operating load can thereby act normally, that is, at right angles to the surfaces of the two connecting partners.

An embodiment is characterized in that the counter centering surface and the centering surface cooperate in a non-positive manner. This type of cooperation can occur as part of step f) “processing”.

In an embodiment, an edge of the cladding tube inner protrusion is provided with a bezel at the first end. The surface created thereby acts as counter centering surface.

An embodiment is characterized in that the positioning template is at least partially shaped in a truncated cone-like manner, wherein the centering surface is at least partially formed in a cladding surface-like manner.

A truncated cone refers to a special rotational body, which is created in that a smaller cone is cut off from a straight circular cone parallel to the base surface. This smaller cone is referred to as supplementary cone of the actual truncated cone. The base surface is the larger one of the two parallel circular surfaces, the cover surface is the smaller one. The third one of the limiting surfaces is referred to as cladding surface. The height of the truncated cone is understood to be the distance from base and cover surface.

The truncated cone-like (or also conical) formation is created by a bending of the side surfaces with respect to the longitudinal axis of the positioning template. By means of this type of handling, the geometric surface of the cladding surface-like centering surface increases with respect to a circumferential surface of the positioning template. By means of the larger surface, the positioning template can therefore reach a higher positioning accuracy.

An embodiment is characterized in that in the region of the first end, the cladding tube is at least partially cut out in a truncated cone-like manner. This type of design provides for a simple self-centering cooperation of the centering surface with the counter centering surface. As part of step d) “attaching”, the cladding surface-like centering surface comes to rest in a non-positive and/or positive manner in the region of the first end of the cladding tube, which is cut out in a truncated cone-like manner. By means of a matching design of the centering surface and of the counter centering surface, the positioning template can be introduced into the first end of the tube. During the insertion of the anti-resonance element preforms through the passage opening as part of step e) “inserting”, the positioning template remains in its position and ensures that the anti-resonance element preforms are arranged at target positions.

An embodiment is characterized in that the attaching as part of step d) “attaching” takes place by means of a flame-based process. In the case of the flame-based process (such as the flame hydrolysis), hydrogen—also referred to as “H2”— is preferably used as combustion gas. It reacts with the oxygen—also referred to as “O2”— in the air. This exothermic reaction creates the energy required in step d).

A heat input, in particular by means of a torch, to the cladding tube takes place thereby. In an embodiment, the heat input takes place at a front surface of the cladding tube in the vicinity of the positioning template. This heat input can in particular take place by means of a focused flame. The heat thereby flows through the front surface of the cladding tube and enters into the tube wall there. The escape of the heat takes place—inter alia—at the cladding tube inner bore. There, the heat then acts on the positioning template, which can lead to a substance-to-substance bond.

In the context of the invention, the term of a substance-to-substance bond is understood to be a connecting of two parts to one another by means of melting as well as by means of intermolecular or chemical bonding forces, optionally via additives. These bonds include in particular welded and soldered connections. At the same time, these are non-releasable connections, which can only be separated by destruction of the connecting means.

An embodiment is characterized in that the anti-resonance element preforms are thermally fixed in a flame-free manner to the cladding tube wall in step f) “processing”. The position of the anti-resonance element preforms in the cladding tube, which is specified by the design of the passage openings in the positioning template, can be as follows:
the anti-resonance element preforms can touch the inner side of the cladding tube inner bore after the step e) “inserting”, or
after the step e) “inserting”, a gap, which is closed in particular during step f) “processing”, can still exist between the anti-resonance element preforms and the inner side of the cladding tube inner bore.

In the case of known methods, the anti-resonance element preforms are thermally fixed to the cladding tube wall by means of a torch by using a flame. An elongating and/or collapsing takes place only thereafter. The formation of soot (name for SiO2 particles) and burn-off turned out to be disadvantageous thereby. These byproducts of the combustion can have different starting points: The combustion of the combustion gas in the torch can take place by forming a flame with a combustible material excess or with an oxidant excess. Known byproducts of a combustion of this type are soot, for instance. The heat input from the torch to the cladding tube can furthermore lead to a local evaporation of the quartz glass. The soot created in this way can subsequently deposit on the individual parts of the preform, in particular on the anti-resonance element preforms. This then leads to a reduction of the quality of the finally produced preform, which becomes apparent in particular in a higher attenuation or in fiber breakages.

The deposition of burn-off or soot forms in particular on the front surface of the cladding tube as well as on the inner surface thereof. The surfaces of the anti-resonance element preforms are furthermore particularly affected. Due to the complexity of the created geometry, a complete cleaning, for example by means of hydrofluoric acid, is hardly possible. Due to the use of the positioning template according to the invention, it is now possible to position the anti-resonance element preforms at the target positions thereof, and to then connect them by means of a substance-to-substance bond to the cladding tube wall by means of the flame-free process as part of step f) “processing”, without the deposit of soot or burn-off in the assembly.

A flame-based attaching or complete connecting of the anti-resonance element preforms with the cladding tube prior to step f) “processing” can be forgone only by means of the use of the positioning template according to the invention, which provides for a precise positioning of the anti-resonance element preforms at target positions due to the self-centering setup. In currently known production methods for preforms of an anti-resonant hollow-core fiber, a flame-based hot-forming process is used in order to weld the anti-resonance element preforms to the cladding tube, so that they maintain the position during elongating and/or collapsing. The disadvantage that the preforms created in this way are contaminated with soot or burn-off, is overcome in accordance with the invention.

An embodiment of the method is characterized in that the cladding tube has a second end. The first end and the second end are located oppositely at the respective outermost end points of the cladding tube.

An embodiment of the method is characterized in that the method comprises the steps of:
(i) creating a second positioning template, having a number of second passage openings passing through the second positioning template, adapted for a longitudinal guidance of an anti-resonance element preform each, wherein the second positioning template and the cladding tube are made of identical material,
(ii) combining the second positioning template with the second end of the cladding tube.

All of the properties described for the positioning template also apply for the second positioning template and vice versa.

The second positioning template can in particular have a second positioning element, such as a cut-out, which cooperates with second counter positioning element at the second end of the cladding tube, and thus prevents a rotation of the second positioning template around its longitudinal axis in this way.

An embodiment of the method is characterized in that the method comprises the steps of:
(iii) inserting at least parts of the anti-resonance element preforms through the passage openings of the second positioning template,
(iv) wherein the second positioning template has at least one second centering surface, which cooperates with the second end of the cladding tube in a self-centering manner in such a way that the anti-resonance element preforms are arranged at target positions in step (iii) “inserting”.

As part of this embodiment, the anti-resonance element preforms are not only held at the target position by means of the positioning template, but by means of a combination of the positioning template and the second positioning template. Both positioning templates have passage openings, through which at least a part of the anti-resonance element preforms can be guided. On its two opposite ends, the anti-resonance element preform can thus be held in the cladding tube by means of the positioning template and the second positioning template. This type of embodiment alternative further increases the precision according to the invention during the positioning of the anti-resonance element preforms at the target positions.

As part of an embodiment, the second positioning template can have at least one cylindrically designed second passage opening. The inner diameter of the at least one second passage opening thereby has a diameter, which is 0.15% to 7%, in particular to 6%, in particular 0.55% to 3.5% larger than the outer diameter of the anti-resonance element preforms. In the case of this type of design, the anti-resonance element preforms can be pushed directly through the passage opening, and can come to rest in a positive and/or non-positive manner against the inner wall of the passage openings in particular over the entire length of the positioning template.

In a further design, at least one of the second passage openings can have a holding region, which serves for the end-side support of the anti-resonance element preforms. Such a holding region can be attained by means of a reduction of the inner diameter of the second passage opening. A holding region arranged in the second passage opening can serve the purpose of limiting a longitudinal movement of the anti-resonance element preforms in the cladding tube inner bore. As part of the preparation of the assembly, at least a part of the anti-resonance element preforms is inserted into the cladding tube inner bore through the passage opening of the positioning template. In this embodiment, the second positioning template, which is attached to the second end of the cladding tube, serves the purpose of ensuring the positioning of the anti-resonance element preforms at the target positions, on the one hand. A longitudinal movement of the anti-resonance element preforms as part of step f) “processing” can furthermore be prevented.

An embodiment of the method is characterized in that the cladding tube is at least partially cut out in the region of the second end in order to form a second counter centering surface, which cooperates with the second centering surface in a positive manner.

An embodiment of the method is characterized in that the second positioning template is at least partially shaped in a truncated cone-like manner, wherein the second centering surface is at least partially formed in a cladding surface-like manner.

An embodiment of the method is characterized in that the cladding tube is at least partially cut out in a truncated cone-like manner in the region of the second end.

An embodiment of the method is characterized in that the method has a step of:
A/ preparing a third positioning template, having a number of third passage openings passing through the third positioning template, adapted for a longitudinal guidance of an anti-resonance element preform each,
   wherein the third positioning template has at least one third centering surface.

As part of steps A/ “preparing”, a third positioning template is created. The third positioning template can have a cylindrical, cover-like, or disk-like shape. In an embodiment, the third positioning template has a transversal extension of 5 to 200 mm, in particular 15 to 80 mm.

The third positioning template and the cladding tube can be designed so as to be made of identical material. In an embodiment, the third positioning template and the cladding tube consist of the same material, in particular of undoped or doped quartz glass (SiO2), wherein the amount of the doping does not exceed 0.1% by weight.

The third positioning template has a number of third passage openings, which pass through the third positioning template. Each third passage opening is set up in such a way so as to establish at least one fluid-conducting connection between the cladding tube inner bore and an outer space through a base body of the third positioning template. The inner diameter of the third passage opening is furthermore designed in such a way that an anti-resonance element preforms can largely be pushed through longitudinally. This statement does not limit the one use of a widening of the ARE outer tube, which serves for the positioning of the anti-resonance element preforms and which will be described in more detail later.

As part of an embodiment, the third positioning template can have at least one cylindrically designed third passage opening. The inner diameter of the at least one third passage opening thereby has a diameter, which is 0.15% to 7%, in particular 0.35% to 6%, in particular 0.55% to 3.5% larger than the outer diameter of the anti-resonance element preforms.

All of the properties described for the positioning template and/or the second positioning template also apply for the third positioning template and vice versa.

All of the properties described for the passage openings and/or the second passage openings also apply for the third passage openings and vice versa.

An embodiment of the method is characterized in that the method comprises the step of:
B/producing a tubular closing element,
   wherein the closing element has an active surface in the region of a first end region in order to cooperate with the third centering surface, in particular to cooperate in a positive manner.

As part of step B/ “producing”, the closing element is created, which is designed to cooperate with the third positioning template. The tubular closing element is furthermore designed to be connected to the cladding tube. The closing element can be designed in a tubular, in particular partially funnel-like manner, and generally has a maximum outer diameter, which corresponds to that of the cladding tube.

The third positioning template and the closing element can be designed so as to be made of identical material. In an embodiment, the positioning template and the cladding tube consist of the same material, in particular of undoped or doped quartz glass (SiO2), wherein the amount of the doping does not exceed 0.1% by weight.

In an embodiment, the closing element and the cladding tube can be designed so as to be made of identical material. In an embodiment, the closing element and the cladding tube consist of the same material, in particular of undoped or doped quartz glass (SiO2), wherein the amount of the doping does not exceed 0.1% by weight.

An embodiment of the method is characterized in that the method comprises the steps of:
C/ linking the third positioning template to the first end region,
D/ connecting the closing element to the second end of the cladding tube,
E/ pushing at least parts of the anti-resonance element preforms through the third passage openings in order to arrange the anti-resonance element preforms in the cladding tube inner bore, wherein
   the third centering surface cooperates with the active surface in a self-centering manner in such a way that the anti-resonance element preforms are arranged at target positions.

As part of step C/ “linking”, a positive bond of the third positioning template with the first end region of the closing element takes place. According to the invention, the third positioning template thereby centers itself due to the cooperation of the active surface with the third centering surface.

As part of a further step, a non-positive and/or substance-to-substance bond can occur between the closing element and the third positioning template. The cooperation of the third centering surface and of the active surface thereby ensures that the relative position of the third positioning template to the closing element does not change.

The third positioning template can in particular have a third positioning element, such as a cut-out, which cooperates with a third counter positioning element at the closing element in order to prevent a rotation of the third positioning template around its longitudinal axis in this way.

As part of step D/ “connecting”, a connecting of the closing element to the second end of the cladding tube takes place. Step D/ “connecting” can in particular lead to a substance-to-substance bond between the closing element and the cladding tube. The third positioning template, as well as the positioning template and/or the second positioning template serves the purpose of ensuring that the anti-resonance element preforms are arranged at target position in the cladding tube and/or the assembly and/or the preform. For this purpose, the third positioning template has third passage openings, which serve to arrange the anti-resonance element preforms. The third passage openings are designed to hold the anti-resonance element preforms. After pushing at least parts of the anti-resonance element preforms through the third passage openings of the third positioning template (step E/), said parts are held at the target positions in the cladding tube inner bore by means of two positioning templates—the positioning template and the third positioning template. Due to the fact that the closing element is arranged at the second end of the cladding tube, and the first positioning template at the first end of the tube, a respective end-side support of the anti-resonance element preforms takes place. This assembly can be processed into a preform as part of step f) “processing” by means of a hot-forming process.

An embodiment is characterized in that the closing element (also referred to as blowpipe) serves to set a negative or positive pressure in the cladding tube. The attaching of the closing element can taken place by means of a thermal method. A first end region of the closing element can thereby be positioned at a distance of 0.5 to 20 mm, in particular 1 to 5 mm, from the second end of the cladding tube. The first end region and the second end are heated up and are subsequently pressed against one another. A positive connection of the two elements is created thereby.

In the case of excessive forces, a local deformation of the first end region of the closing element and/or of the second end of the cladding tube can occur as part of step D/“connecting”. If this deformation occurs in the region of the positioning template, it can have a negative impact on the anti-resonance element preforms and/or the positioning thereof. To reduce the risk of a potential local deformation of the first end region of the closing element and/or of the second end of the cladding tube as part of step D/“connecting”, an embodiment is characterized in that the preform has a first connecting element. The first connecting element can be designed in a tubular manner and can have a connecting element inner bore and a connecting element longitudinal axis, along which a connecting element wall extends, which is limited by an inner side and an outer side. The first connecting element and the cladding tube can be designed so as to be made of identical material. The first connecting element acts as a type of buffer between the cladding tube and the closing element. Both are not connected directly, and a potential deformation in the region of the positioning template is prevented. Therefore,
a first end section of the first connecting element can be attached to the second end of the cladding tube and/or
a second end section of the first connecting element can be attached to the first end region of the closing element.

The first connecting element can also serve to hold the cladding tube and/or to set a negative or positive pressure in the cladding tube.

An embodiment is characterized in that the preform has a second connecting element. The second connecting element can be designed in a tubular manner and can have a connecting element inner bore and a connecting element longitudinal axis, along which a connecting element wall extends, which is limited by an inner side and an outer side. Just like the first connecting element, the second connecting element can serve to hold the cladding tube and/or to set a negative or positive pressure in the cladding tube. A first end section of the second connecting element can therefore be attached to the first end of the cladding tube. The second connecting element and the cladding tube can be designed so as to be made of identical material.

An embodiment is characterized in that a diameter of the connecting element inner bore of the first and/or second connecting element is 2-15% larger, in particular 5-10% larger, than a diameter of the cladding tube inner bore. The larger inner diameter of the first and/or second connecting element can make it possible to guide the respective positioning template through the connecting element, and to position it in the cladding tube. The first and/or second connecting element can have a length of 50 mm to 150 mm in order to effectively prevent a potential deformation in the region of at least one of the first, second, or third positioning template.

Step f) “processing” can be designed in a flame-free manner, so that no soot or burn-off deposits on the anti-resonance element preforms. With the use of the positioning template, in particular with the use of the positioning template in combination with the second and/or third positioning template, it is possible to support the anti-resonance element preforms at target positions in the cladding tube and/or the assembly in such a precise manner that a flame-based linking of the anti-resonance element preforms with the cladding tube is not required prior to the hot process as part of step f) “processing”. This option does not only increase the efficiency compared to already known production methods, but also reduces the attenuation in the finished preform and the finished anti-resonant hollow-core fiber.

An embodiment of the method is characterized in that at least one of the following steps comprises a flame-free thermal connecting or a flame-based thermal connecting:
step b) “preparing”,
step d) “attaching”,
step (ii) “combining”,
step C/ “linking”, and
step D/ “connecting”.

To achieve a process, which can be carried out in a technically quick manner, it can be advantageous to create certain elements of the assembly as part of flame-based thermal processes. These are in particular those elements of the assembly, which can also be subjected to a cleaning step prior to the processing step f) “processing”. In particular step b) “preparing” and step d) “attaching” can thus take place in a cost-efficient manner as part of a flame-based thermal process. However, both the anti-resonance element preforms and the combination of cladding tube and positioning template have to be cleaned subsequently in order to remove resulting deposits of soot or burn-off. The statement made also applies for at least one of steps (ii) “combining” and C/ “linking” and D/ “connecting”.

If, in contrast, the focus is on the precision of the assembly of the anti-resonance element preforms in the preform and/or on a reduction of the attenuation, it can be advantageous to perform the mentioned steps as part of a flame-free thermal connecting.

An embodiment of the method is characterized in that the method comprises at least one of the steps of:
thermal fixing, in particular flame-free thermal fixing, of at least some of the anti-resonance element preforms to the positioning template, and/or
thermal fixing, in particular flame-free thermal fixing, of at least some of the anti-resonance element preforms to the second positioning template, and/or,
thermal fixing, in particular flame-free thermal fixing, of at least some of the anti-resonance element preforms to the third positioning template.

An embodiment of the method is characterized in that prior to step f) “processing”, the anti-resonance element preforms are only held by means of
the positioning template, or
the positioning template and the second positioning template, or
the positioning template and the third positioning template

and otherwise without a substance-to-substance bond in the cladding tube inner bore.

With the use of the positioning template, in particular in combination with the second and/or third the positioning template it is possible to position the anti-resonance element preforms in the cladding tube inner bore at the target positions with such a precision that no thermal connecting of the anti-resonance element preforms to the cladding tube inner bore is required prior to the elongating and/or collapsing as part of step f) “processing”,

By means of the self-centering design of the positioning template as well as of the second or third positioning template, it is ensured that even during a handling of the assembly, the anti-resonance element preforms still remain at the respective target position. A substance-to-substance bond between the antiresonance element preforms and the cladding tube inner bore is therefore not required.

An embodiment of the method is characterized in that in some regions, preferably at a first end of the anti-resonance element preform, the ARE outer tube has a widening of the outer diameter, which is larger than an inner diameter of at least one of the passage openings, the second passage openings, and the third passage openings.

The widening of the outer diameter serves the purpose of having a specified holding point at an anti-resonance element preform, if the latter is guided in at least one of the passage openings, the second passage openings, and the third passage openings. Via the arrangement of the widening on the anti-resonance element preform, the longitudinal position thereof in the cladding tube can be controlled.

An embodiment of the method is characterized in that in some regions, preferably at a second end of the anti-resonance element preform, the ARE has a tapering of the outer diameter, which is smaller than an inner diameter of at least one of the passage openings, of the second passage openings and/or of the third passage openings.

The tapering serves the purpose that the anti-resonance element preform can be inserted more easily into at least one of the passage openings, the second passage openings, and the third passage openings. It is a further advantage that the number of edges is reduced, and the risk of a splintering of the anti-resonance element preforms during the inserting and/or positioning of the anti-resonance element preforms in the passage opening is reduced significantly.

An embodiment of the method is characterized in that the positioning template and/or the second positioning template and/or the third positioning template has at least one gas flow element, which connects the cladding tube inner bore in a fluid-conducting manner to the surrounding area of the preform.

The gas flow element can be a bore, which completely passes through the positioning template and/or the second and/or the third positioning template. It is the goal to establish a fluid-conducting connection of the cladding tube inner bore with the surrounding area of the preform. Said connection serves the purpose of controlling the inner pressure in the cladding tube inner bore.

An embodiment is characterized in that the cladding tube inner bore is created by means of machining, in particular by means of drilling, milling, grinding, honing, and/or polishing. Compared to other known shaping techniques, these machining techniques provide more exact and more delicate structures by using heat and pressure, and avoid contaminations of the surfaces caused by forming tools.

An embodiment is characterized in that the cladding tube has an outer diameter in the range of 65 to 300 mm, in particular 90 to 250 mm, and in particular a length of at least 1 m. The accuracy of the positioning of the anti-resonance element preforms in the cladding tube is improved, in that tubular structural elements are provided, at least a part of which has a wall thickness in the range of 0.2 and 2 mm, preferably a wall thickness in the range of 0.25 and 1 mm, and wherein a cladding tube with an outer diameter in the range of 65 to 300 mm, preferably with an outer diameter in the range of 90 to 250 mm, preferably with an outer diameter in the range of 120 to 200 mm, is provided. These components can thereby additionally each have a length of at least 1 m.

Large-volume structural elements of this type (anti-resonance element preforms, ARE inner tube or ARE outer tube) simplify the handling. In the case of a vertical arrangement of cladding tube and structural element, the force of gravity additionally supports the parallelism and the vertical alignment of the longitudinal axes anti-resonance element preforms, when the anti-resonance element preforms are in each case positioned at the target position on their upper front-side end.

The above-mentioned objects are also solved by means of a method for producing a secondary preform, from which an anti-resonant hollow-core fiber can be drawn, from a preform, produced according to any one of the preceding embodiments, having the step of
further processing the preform into the secondary preform,
wherein the further processing comprises a one-time or repeated performance of one or several of the following hot-forming processes:
i.) elongating,
ii.) collapsing,
iii.) collapsing and simultaneous elongating,
iv.) adding additional cladding material,
v.) adding additional cladding material and subsequent elongating,
vi.) adding additional cladding material and simultaneous elongating.

A preform is the starting point for the production of the anti-resonant hollow-core fiber. In the method according to the invention, the preform is further processed into a secondary preform by performing one or several hot-forming processes.

During the elongating, the preform is lengthened. The lengthening can take place without simultaneous collapsing. The elongating can take place to scale, so that, for example, the shape and arrangement of components or component parts of the primary preform are reflected in the elongated end product. During the elongating, however, the primary preform can also be drawn not to scale, and the geometry thereof can be changed. During the collapsing, an inner bore is narrowed or ring gaps are closed or narrowed between tubular components. The collapsing is generally associated with an elongating. The secondary preform produced in this way can already be designed and suitable for drawing a hollow-core fiber. The secondary preform can optionally be further processed in that it is, for example, elongated, or additional cladding material is added to it.

The above-mentioned objects are also solved by means of a method for producing an anti-resonant hollow-core fiber from a preform, produced according to any one of the preceding embodiments, having the step of
further processing the preform into the anti-resonant hollow-core fiber, wherein the further processing comprises a one-time or repeated performance of one or several of the following hot-forming processes:
i.) elongating,
ii.) collapsing,
iii.) collapsing and simultaneous elongating,
iv.) adding additional cladding material,
v.) adding additional cladding material and subsequent elongating,
vi.) adding additional cladding material and simultaneous elongating.

A preform is the starting point for the production of the anti-resonant hollow-core fiber. The anti-resonant hollow-core fiber is created by means of a hot process, in particular by elongating the preform.

During the elongating, the preform is lengthened. The elongating can take place to scale, so that, for example, the shape and arrangement of components or component parts of the primary preform are reflected in the elongated end product. During the elongating, however, the primary preform can also be drawn not to scale, and the geometry thereof can be changed. During the collapsing, an inner bore is narrowed or ring gaps are closed or narrowed between tubular components.

To elongate and create the anti-resonant hollow-core fiber from the preform, the preform can be guided perpendicularly through a furnace. A lower end of the preform, from which the anti-resonant hollow-core fiber is drawn in the form of a cone, is thereby warmed up to drawing temperature, wherein the drawn fiber is subsequently cooled down from the drawing temperature by means of a gas stream, which is directed opposite to the drawing direction.

In an embodiment, the anti-resonant hollow-core fiber is coated with an adhesion-promoting agent, wherein this step is performed during the drawing process during the glass fiber production, and the anti-resonant hollow-core fiber is subsequently coated with a plastic in a second subsequent step. This second step can be performed so as to be decoupled in terms of time from the drawing process of the glass fiber production. The plastic used for the coating can be one or several of the following substances: polyurethane acrylates, acrylates, polyolefins, polyamides (nylon), polyethers, polyurethane monoacrylates, fluoroalkyl methyiacrylates, or polyimide.

An embodiment is characterized in that a relative inner pressure (a negative pressure compared to the ambient atmospheric pressure) in the range of between −10 to −300 mbar, in particular −50 to −250 mbar, is set in the cladding tube inner bore in at least one of steps f) “processing” and “further processing” of the assembly as part of the elongating and/or collapsing. This pressure window ensures that the OD/ID ratio (ratio of outer diameter to inner diameter of the cladding tube) does not become too small as part of the elongating and/or collapsing.

An embodiment is characterized in that that a relative inner pressure (a positive pressure compared to the ambient atmospheric pressure) in the range of between 0.05 mbar-20 mbar is set in the core region in step “further processing” as part of the elongating of the preform into an anti-resonant hollow-core fiber. In the case of a relative inner pressure of less than 0.05 mbar, it may happen that the anti-resonance element preforms inflate too much. Vice versa, a relative inner pressure of more than 20 mbar in the core region can have the result that the gas pressure within the hollow ducts of the anti-resonance element preforms is not sufficient, so that they widen sufficiently in the hot-forming process.

The temperature of a heating zone during the hot-forming process should be as constant as possible. Advantageously, a temperature-controlled heating element is thus used during the hot-forming process, the target temperature of which is held exactly at +/−0.1° C. Temperature fluctuations in the hot-forming process can thus be limited to less than +/−0.5° C.

All of the properties and features described for the passage openings also apply for the second passage openings and/or the third passage openings and vice versa.

All of the properties and features described for the positioning template also apply for the second positioning template and/or the third positioning template and vice versa.

The properties and features disclosed in the description can be significant for various designs of the claimed invention, both separately and in any combination with one another. The properties and features disclosed for the preform or the anti-resonant hollow-core fiber are also disclosed for the method and vice versa.

The invention will be illustrated further in an exemplary manner below by means of figures. The invention is not limited to the figures.

### FIGURES

FIG. 1 shows a partial longitudinal section through an anti-resonant hollow-core fiber,

FIG. 2 shows a partial cross section through an anti-resonant hollow-core fiber,

FIG. 3 shows a partial longitudinal section through elements of a first embodiment of an assembly,

FIG. 4 shows an assembly according to FIG. 3,

FIG. 5 shows the preform according to FIGS. 3 and 4,

FIG. 6 shows a partial longitudinal section through elements of a further embodiment of an assembly,

FIG. 7 shows an assembly according to FIG. 6,

FIG. 8 shows the preform according to FIGS. 7 and 8,

FIG. 9 shows a further embodiment of an assembly,

FIG. 10 shows the assembled preform according to FIG. 9,

FIG. 11 shows the embodiment illustrated in FIG. 9, supplemented by a connecting element,

FIG. 12 shows the assembled preform according to FIG. 11,

FIG. 13 shows a first embodiment of a positioning template,

FIG. 14 shows a further embodiment of a positioning template,

FIG. 15 shows a further embodiment of a positioning template,

FIG. 16 shows a partially assembled preform comprising a positioning template according to FIG. 13,

FIG. 17 shows a preform in step f) “processing”,

FIG. 18 shows a flow chart of a method for producing a preform, and

FIG. 19 shows a flow chart of a method for producing an anti-resonant hollow-core fiber.

### DESCRIPTION OF THE FIGURES

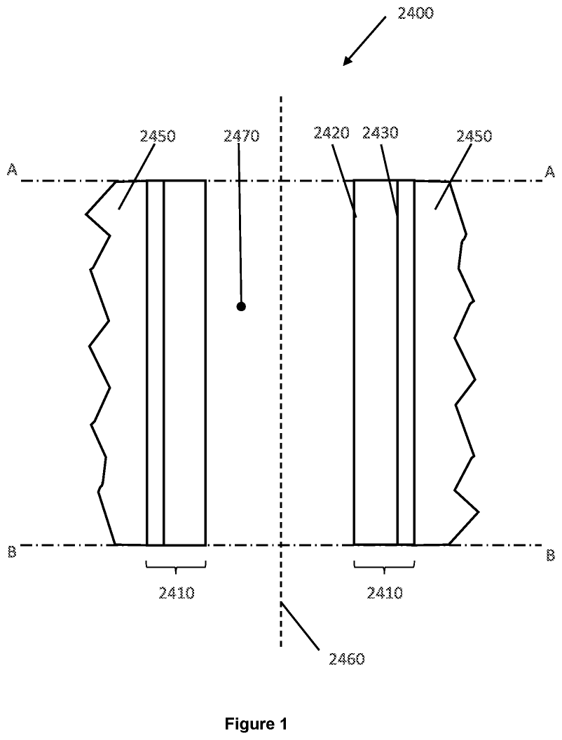

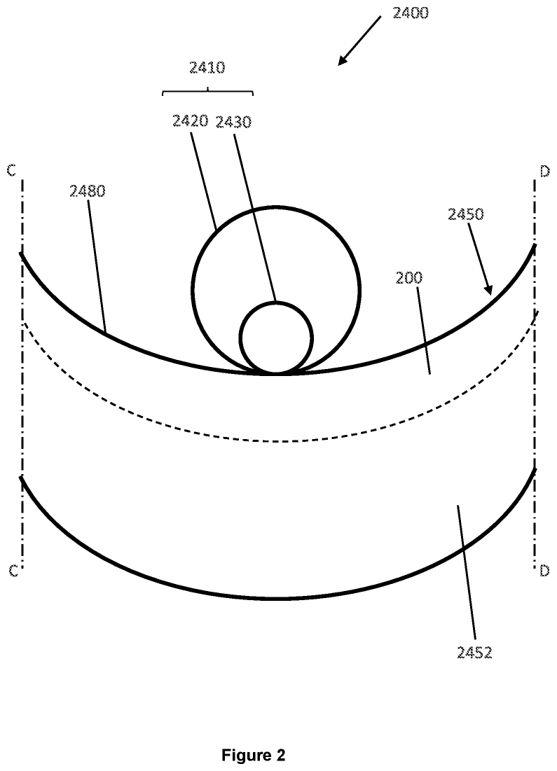

FIG. 1 shows a longitudinal section through an anti-resonant hollow-core fiber 2400. What is illustrated is a section of the anti-resonant hollow-core fiber 2400 between 2 sectional lines A-A and B-B. The anti-resonant hollow-core fiber 2400 has a cladding 2450. In the illustrated embodiment of the anti-resonant hollow-core fiber 2400, the cladding 2450 consists of an elongated cladding tube 200 and an elongated cladding material 2452. Due to the fact that the cladding material 2452 and the cladding tube material 200 are designed to be of identical material in the illustrated embodiment, the transition between the two materials in FIG. 2 is marked by means of a dashed line. The anti-resonant hollow-core fiber 2400 has a hollow core 2470. An electromagnetic wave can propagate through the hollow core 2470. In the illustrated embodiment, two anti-resonance elements 2410 are arranged inside the hollow core 2470. They are connected by means of a substance-to-substance bond to an inner surface 2480 of the cladding 2450. The anti-resonance elements 2410 have an ARE fiber outer tube 2420 and an ARE fiber inner tube 2430. The ARE fiber inner tube 2430 is arranged in the ARE fiber outer tube 2420. The anti-resonance elements 2410 are arranged parallel to a longitudinal axis 2460 of the anti-resonant hollow-core fiber 2400.

FIG. 2 shows a cross section of the anti-resonant hollow-core fiber 2400, which is illustrated in FIG. 1. This FIG. 2 clarifies the arrangement of an anti-resonance element 2410 on an inner surface 2480 limiting the hollow core 2470. The anti-resonance elements 2410 are constructed in a tubular manner, wherein the ARE fiber inner tube 2430 is connected by means of a substance-to-substance bond to the ARE fiber outer tube 2420. The illustrated ARE fiber inner tube 2430 and/or ARE fiber outer tubes 2420 can partially have a wall thickness in the range of 0.2-2 μm. The illustrated cladding tube 2450 can have an outer diameter in the range of 90-250 mm with a length of at least 1 m. The inner diameter of the hollow core 2470 is preferably 10-50 millimeters.

The illustrated anti-resonant hollow-core fiber 2400 is produced from a preform 100, which will be described in more detail below. The production of the anti-resonant hollow-core fiber 2400 from the preform 100 thereby takes place in particular by means of a one-time or repeated performance of one or several of the following hot-forming processes: elongating 2300, collapsing 2100, adding 2200 additional cladding material.

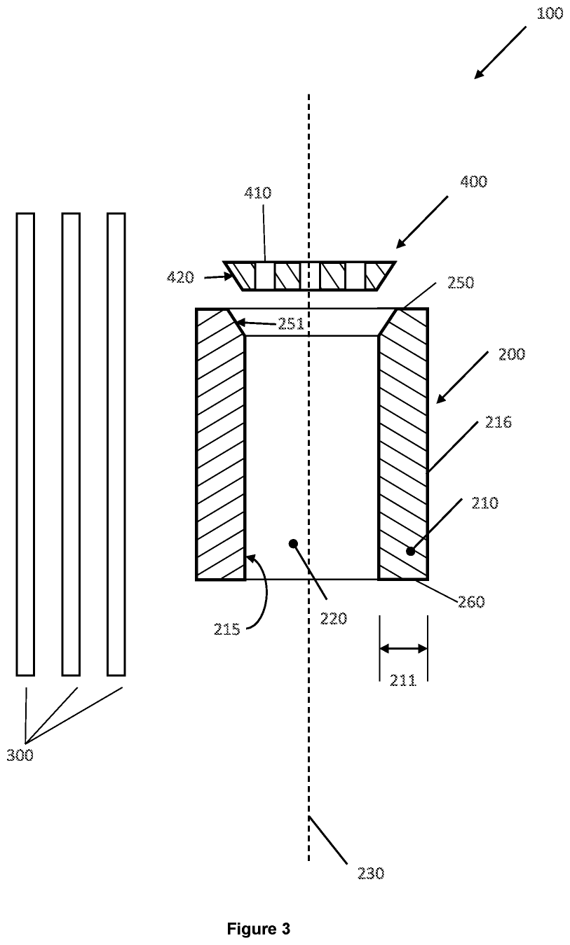

FIG. 3 shows individual parts of a first embodiment of an assembly 110 of a preform 100 according to the invention of an anti-resonant hollow-core fiber 2400. The assembly 110 has a cladding tube 200. The cladding tube 200 is designed in a tubular manner and comprises a cladding tube wall 210, which has a thickness 211 in the range of 20 mm to 90 mm. An anti-resonance element preform 300 is to be arranged on an inner side 215 of the cladding tube 200 as part of the method. The anti-resonance elements 2410 are created from these anti-resonance element preforms 300 by means of corresponding processes.

In the case of known methods, the anti-resonance element preforms 300 are individually placed into a cladding tube 200. A graphite element can be used to position the anti-resonance element preforms 300. Due to the tube geometries and tolerances, these graphite elements are manufactured with a gap size, which, however, leads to a play for the graphite element as well as for the anti-resonance element preforms 300. If, for example, six anti-resonance element preforms 300 are thus inserted, it cannot be ensured that an exact angular distance of 60° is always maintained. By means of the described technique, it is furthermore possible that the anti-resonance element preforms rotate radially over the length of the tube.

In the case of known methods, a fixing of the anti-resonance element preforms 300 takes place subsequently at the two front surfaces of the cladding tube 200. This takes place via pointwise melting by means of a manual torch. Soot or burn-off, which deposits on the glass surfaces, is created thereby. This generally affects in particular the front surface of the cladding tube as well as the inner surface thereof and the surfaces of the anti-resonance element preforms. Due to the complexity of the created geometry, a complete cleaning of the assembly is hardly possible.

To overcome these disadvantages, the following method 2000 for producing a preform 100 of an anti-resonant hollow-core fiber 2400 is disclosed, comprising the method steps of
a) providing 1000 a cladding tube 200, which has a cladding tube inner bore 220 and a cladding tube longitudinal axis 230, along which a cladding tube wall 210 extends, which is limited by an inner side 215 and an outer side 216,
b) preparing 1100 a number of anti-resonance element preforms 300, each comprising an ARE outer tube 310 and an ARE inner tube 320 inserted therein,
c) preparing 1200 a positioning template 400, having a number of passage openings 410 passing through the positioning template 400, adapted for a longitudinal guidance of an anti-resonance element preform 300 each, wherein the positioning template 400 and the cladding tube 200 are made of identical material,
d) attaching 1300 the positioning template 400 to a first end 250 of the cladding tube 200,
e) inserting 1400 at least parts of the anti-resonance element preforms 300 through the passage openings 410 for arranging the anti-resonance element preforms in the cladding tube inner bore 220,
f) processing 1500 an assembly 100, comprising the cladding tube 200, the anti-resonance element preforms 300, and the positioning template 400, by means of a hot-forming process, selected from at least one of elongating and collapsing.

It is provided thereby that the method is designed in such a way that the positioning template 400 has at least one centering surface 420, which cooperates with the first end 250 of the cladding tube 200 in a self-centering manner in such a way that the anti-resonance element preforms 300 are arranged at target positions in step e) “inserting” 1400.

What takes place in step c) “preparing” 1200 is a creating of the positioning template 400, having a number of passage openings 410 passing through the positioning template 400, adapted for a longitudinal guidance of an anti-resonance element preform 300 each, wherein the positioning template 400 and the cladding tube 200 are made of identical material.

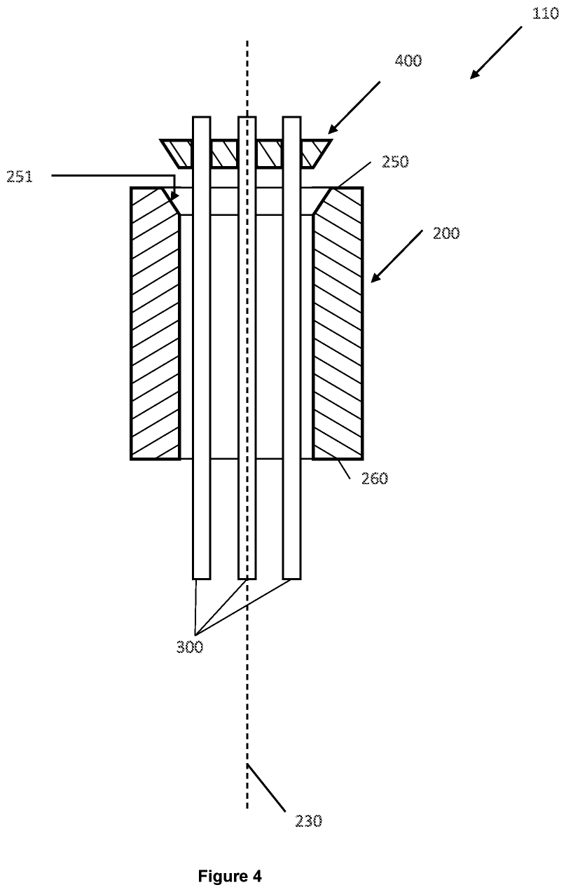

In FIG. 4, parts of the anti-resonance element preforms are guided through the passage openings 410 and protrude into the cladding tube inner bore 220 (step e) “inserting” 1400). The positioning template 400 is lowered in the direction of the cladding tube 200 as part of step d) “attaching” 1300. After the non-positive and/or positive attaching of the positioning template 400 to the cladding tube 200, the assembly 110, comprising the cladding tube 200, the anti-resonance element preforms 300, and the positioning template 400 is further processed by means of the hot-forming process into the preform 100, selected from at least one of elongating and collapsing.

The positioning template 400, which is to be used is designed in such a way that the passage openings 410 for the anti-resonance element preforms 300 are always located at the same angular distance from one another, and that a symmetry is thus automatically at hand. A gas flow element for the gas flow is furthermore provided in the center of the disk. In the later process, for example the rinsing or cleaning with gas, as well as the application of negative pressure, is thus possible within the entire tube setup in the later process. Due to the size of the bore, the gas flow through the core region and the anti-resonance element preforms can be influenced.

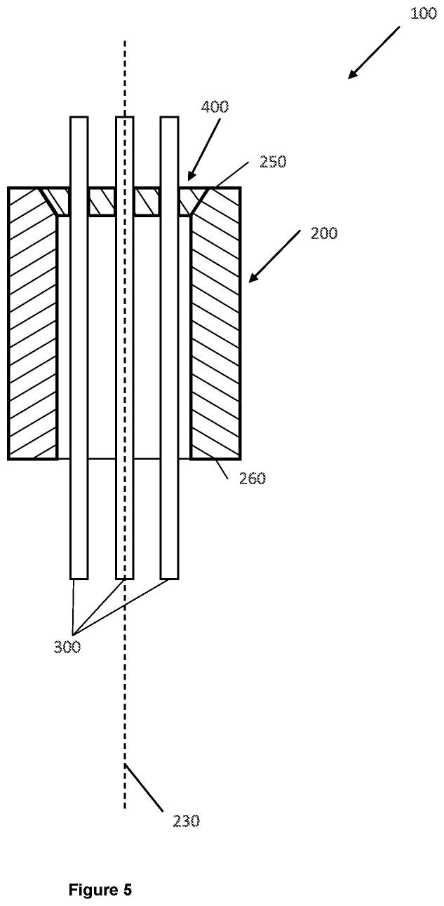

FIG. 5 shows the preform 100. Due to the self-centering cooperation of the centering surface 420 of the positioning template 400 with the first end 250 of the cladding tube 200, the anti-resonance element preforms remain at predefined target positions in step e) “inserting” 1400 and in particular also in step f) “processing” 1500.

It is an aspect of the method that the exact joining of cladding tube 200 and anti-resonance element preforms 300 can take place directly in a processing plant (generally a vertical glass lathe) and only one process step is thus necessary for assembly and stretching of the entire preform.

An embodiment of the method 2000 is characterized in that the anti-resonance element preforms 300 are thermally fixed in a flame-free manner to the cladding tube wall 210 in step f) “processing” 1500. A previous, pointwise partial melting of the anti-resonance element preforms 300 and the cladding tube 200, in particular the cladding tube wall 210, in particular by means of the manual torch, can be dispensed with.

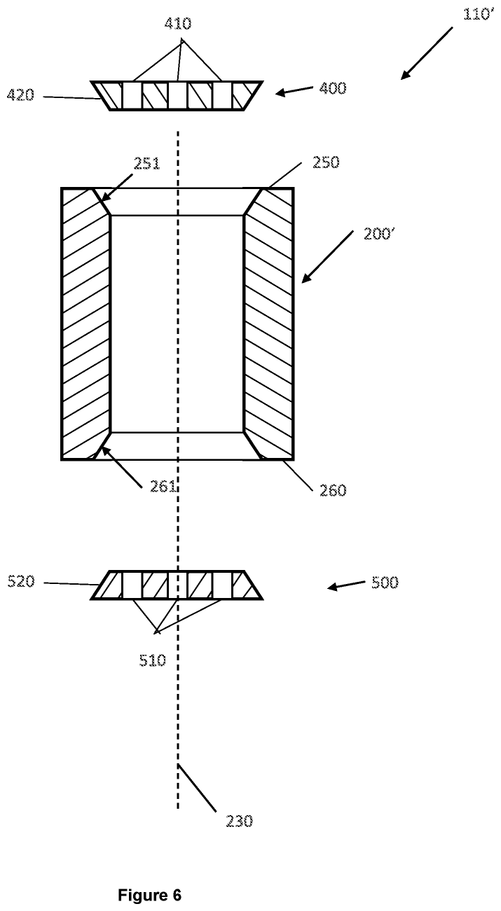

FIGS. 6, 7, and 8 show a further embodiment of the assembly 110′ and of the preform 100′, which is produced by means of the disclosed method. The embodiment according to FIGS. 6, 7, and 8 largely corresponds to the embodiment, which is described above and which is illustrated in FIGS. 3, 4, 5, and 6, so that reference is made to the above description in order to avoid repetitions. A structure, which is repeated from the description of FIGS. 3, 4, 5, and 6, has the same reference numeral. Modifications of a structure compared to the structure shown in FIGS. 3, 4, 5, and 6, have the same reference numeral with an apostrophe (′).

In contrast to FIGS. 3 and 4, the shown cladding tube 200′ has a counter centering surface 251 not only on the first end 250. In addition, the cladding tube 200′ has a second counter centering surface 261 on a second end 260. As part of the method, the steps of:
(i) creating a second positioning template 500, having a number of second passage openings 510 passing through the second positioning template 500, adapted for a longitudinal guidance of an anti-resonance element preform 300 each, wherein the second positioning template 500 and the cladding tube 200′ are made of identical material,
(ii) combining the second positioning template 500 with the second end 260 of the cladding tube 200′ are provided.

In the illustrated embodiment, the positioning template 500 is at least partially shaped in a truncated cone-like manner. The second centering surface 520 is thereby partially formed in a cladding surface-like manner.

The cladding tube 200′ is at least partially cut out in the region of the second end 260 in order to form a second counter centering surface 261, which can cooperate in a positive manner with the second centering surface 520. In FIG. 6, the cladding tube 200′ is cut out at least partially in a truncated cone-like manner in the region of the second end 260.

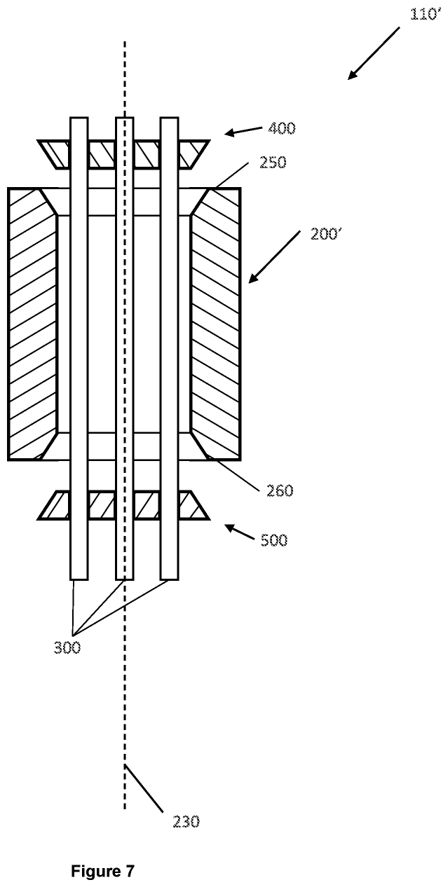

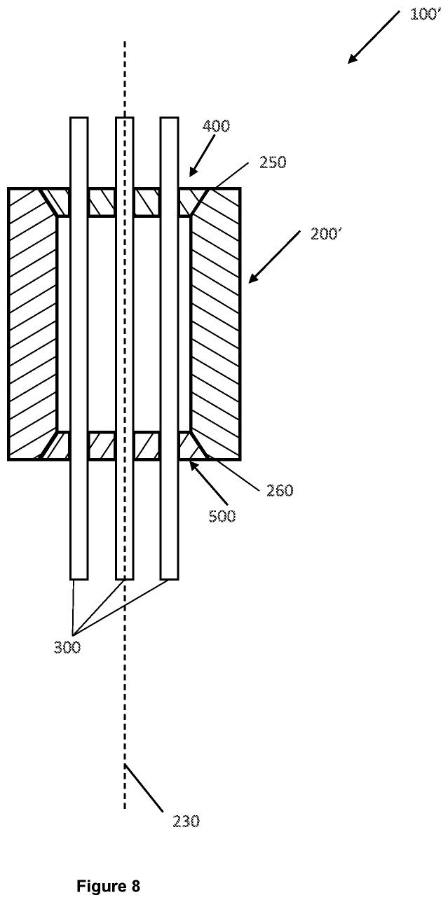

FIG. 7 shows the step (iii) “inserting” of at least parts of the anti-resonance element preforms 300 through the second passage openings 510 of the second positioning template 500. Step f) “processing” 1500 of the assembly, comprising the cladding tube 200′, the anti-resonance element preforms 300, and the positioning template 400 and the second positioning template 500 takes place subsequently by means of a hot-forming process, selected from at least one of elongating and collapsing. Combined, the second centering surface 520 cooperates with the second end 260 of the cladding tube 200′ in a self-centering manner in such a way that the anti-resonance element preforms are arranged at target positions in step (iii) “inserting” and in particular in step f) “processing” 1500, as clarified in FIG. 8.

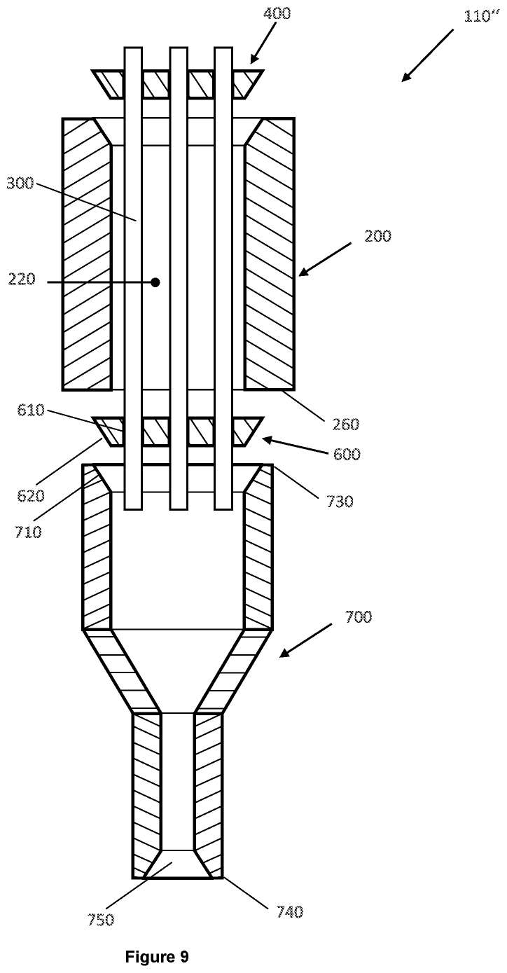

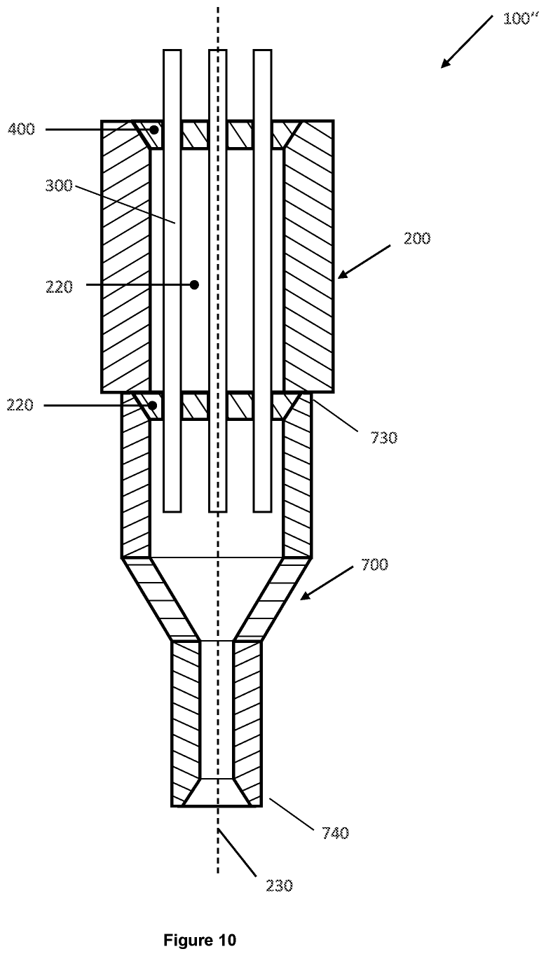

FIGS. 9 and 10 show an embodiment of an assembly 110″ and of a preform 100″, which is produced by means of the disclosed method. The embodiment according to FIGS. 9 and 10 largely corresponds to the embodiment, which is described above and which is illustrated in FIGS. 3, 4, 5, and 6, so that, to avoid repetitions, reference is made to the above description. A structure, which is repeated from the description of FIGS. 3, 4, 5, and 6, has the same reference numeral. Modifications of a structure compared to the structure shown in FIGS. 3, 4, 5, and 6, have the same reference numeral with two apostrophes (″).

FIG. 9 shows the assembly 110″, which can be shaped into a preform 100″ by elongating and/or collapsing as part of step f) “processing”. The method required for this purpose comprises the step of:
A/preparing a third positioning template 600, having a number of third passage openings 610 passing through the third positioning template 600, adapted for a longitudinal guidance of an anti-resonance element preform 300 each, wherein the third positioning template 600 has at least one third centering surface 620.

To create the illustrated preform 100″, the step of
B/producing a tubular closing element 700, wherein the closing element 700 has an active surface 710 in the region of a first end region 730 in order to cooperate with the third centering surface 620, in particular to cooperate in a positive manner,

is required.

The illustrated assembly 110″ has a funnel-like closing element 700. The outer diameter of the closing element 700 in the first end region 730 corresponds essentially to that outer diameter of the cladding tube 200. On the opposite second end region 740, the diameter of the closing element 700 is reduced in order to form an outlet 790. This outlet 790 can, inter alia, serve to regulate the pressure ratios in the at least one anti-resonance element preform 300 in or inside the cladding tube inner bore 220, respectively.

FIG. 10 shows the finished preform 100″, which—based on FIG. 9—is created after passing through the following steps
C/ linking the third positioning template 600 to the first end region 730,
D/ connecting the closing element 700 to the second end 260 of the cladding tube 200,
E/ pushing at least parts of the anti-resonance element preforms 300 through the third passage openings 610 in order to arrange the anti-resonance element preforms 300 in the cladding tube inner bore 220, wherein the third centering surface 620 cooperates with the active surface 710 in a self-centering manner in such a way that the anti-resonance element preforms 300 are arranged at target positions.

In the illustrated exemplary embodiment, the anti-resonance element preforms 300 are held at two positions on the end side. On the one hand, the anti-resonance element preforms 300 are held at the first end 250 of the cladding tube 200 by means of the positioning template 400. In addition, the third positioning template 600 ensures a further end-side holding of the anti-resonance element preforms 300. Together, the positioning template 400 and the third positioning template 600 ensure that the anti-resonance element preforms 300 are held at target positions inside the cladding tube inner bore 220.

In step f) “processing”, the anti-resonance element preforms 300 can be thermally fixed in a flame-free manner to the cladding tube inner bore. In particular FIG. 17, which illustrates the pass-through of the assembly through an electric furnace 800 as part of step f) “processing”, clarifies this step. Reference is therefore made to the statements made there.

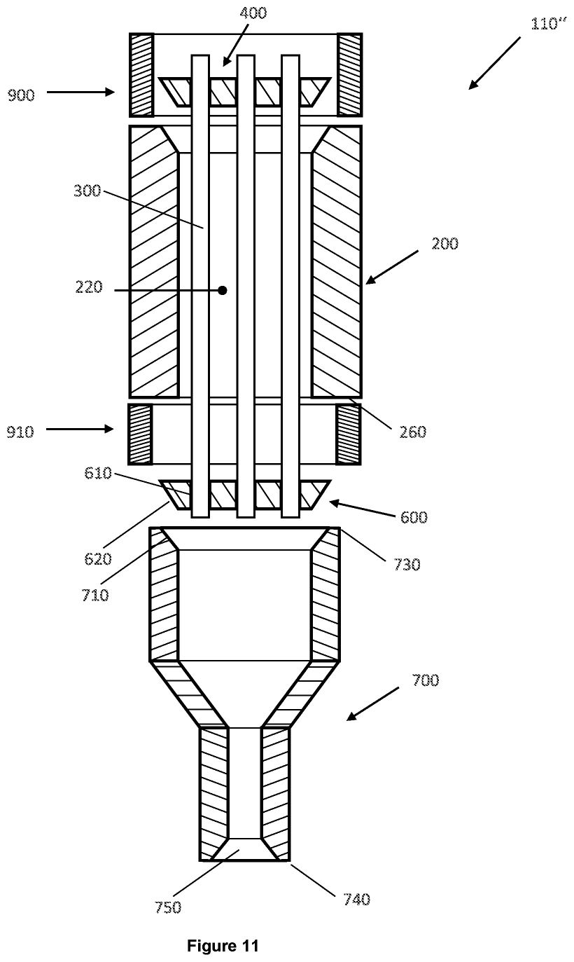

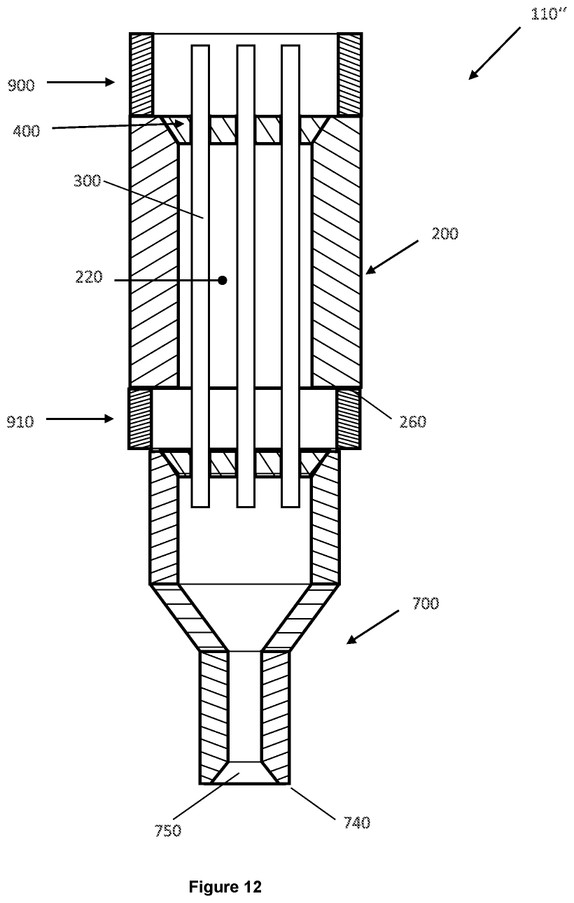

FIGS. 11 and 12 show an embodiment of an assembly 110″ and of a preform 100″, the outer shape of which is analogous to the shape illustrated in FIGS. 9 and 10. To avoid repetitions, reference is therefore made to the above description. In contrast, the assembly 110″ has a first connecting element 900 and a second connecting element 910. The first connecting element 900 is thereby arranged at the first end 250 of the cladding tube 200, and the second connecting element 910 is arranged at the second end 260 of the cladding tube.

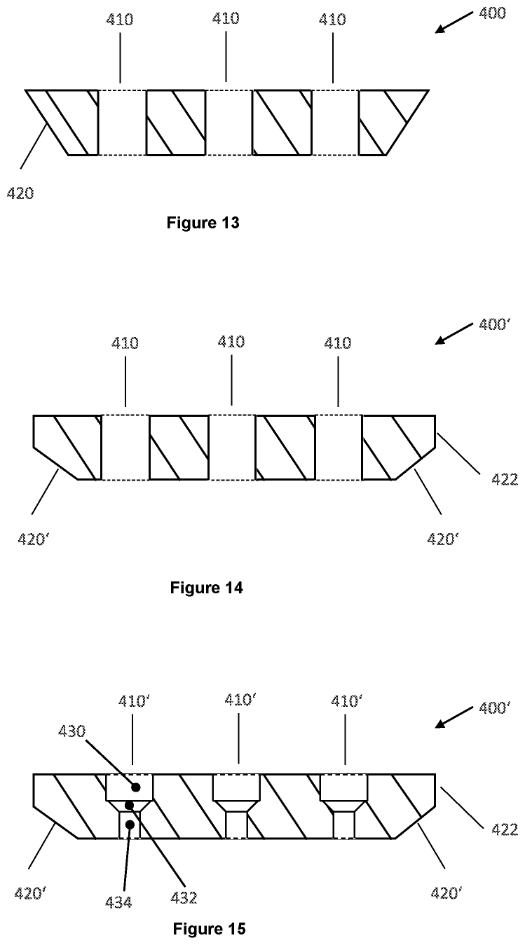

FIGS. 13 to 15 show different embodiment of the positioning template 400, 400′, 400″.

A disk-like positioning template 400 is illustrated in FIG. 13. This positioning template is shaped in a truncated cone-shaped manner, so that the side surfaces completely form the centering surfaces 420. The passage openings 410 are designed in a tubular manner, and have a consistent inner diameter 411 over the longitudinal extension thereof.

The difference between the inner diameter of the passage openings 410 and an outer diameter of the anti-resonance element preform 300 should be between 0.15% to 7%, in particular 0.35% to 6%, in particular 0.55% to 3.5%.

The positioning template 400′ in FIG. 14 has side surfaces, which are inclined more strongly and which form the centering surfaces 420. Collar region 422 is arranged above the centering surfaces 420. The first end 250 of the cladding tube 200 can be designed in such a way that
only the counter centering surface 251 cooperates with the centering surface 420, or
on the one hand, the counter centering surface 251 cooperates with the centering surface 420 and, on the other hand, the collar region 422 cooperates with a counter collar region at the cladding tube 200, in particular in a positive and/or non-positive manner. Such a cooperation intensifies the self-centering effect.

The passage openings 410 are shaped in a tubular manner.

FIG. 15 shows an embodiment of the positioning template 400″, the outer shape of which is analogous to the shape illustrated in FIG. 14. In contrast, the positioning template 400″ does not have any tubular passage openings 410, which have a consistent inner diameter. On the contrary, the passage openings 410′ are designed in a tubular manner in sections, wherein two sections have a different inner diameter. The passage openings 410′ have
a receiving region 430, which is designed in a tubular manner and the inner diameter of which is adapted to the outer diameter of the of the anti-resonance element preforms 300 in order to be able to guide them at least partially,
a holding region 434, which is designed in a tubular manner and the inner diameter of which is smaller than the outer diameter of the anti-resonance element preforms 300, and which is designed to hold the anti-resonance element preforms 300, and
a funnel-like transition region 432, which connects the receiving region 430 and holding region 434.

This type of design of the passageways 410 can fulfill two objects. The receiving region 430 serves in particular to position the anti-resonance element preforms 300 in the cladding tube inner bore 220. The primary object of the receiving region 430 is thus a preventing of transversal movements of the anti-resonance element preforms 300. The holding region 434, in contrast, serves primarily to prevent a longitudinal movement of the respective anti-resonance element preform 300.

All of the illustrated features and described properties for the positioning template 400, 400′, 400″ in FIGS. 13 to 15 also apply for the second positioning template 500 and/or for the third positioning template 600.

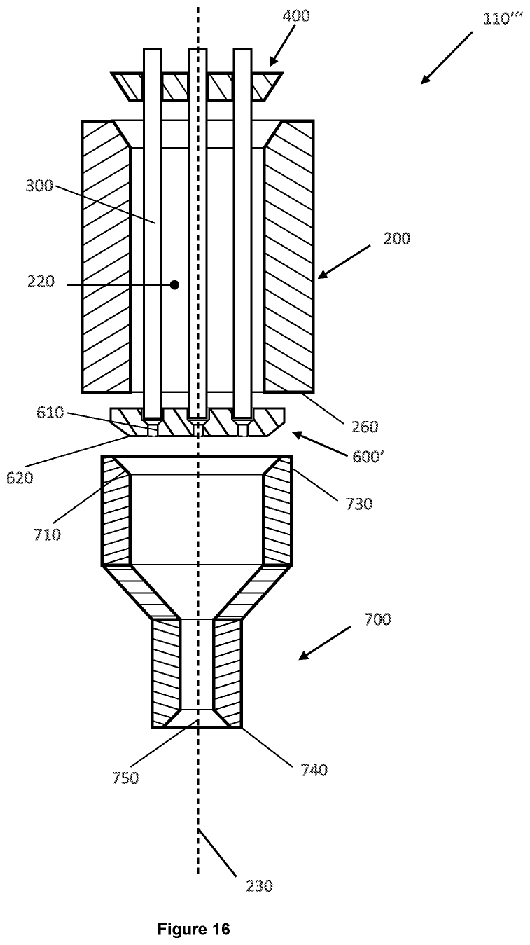

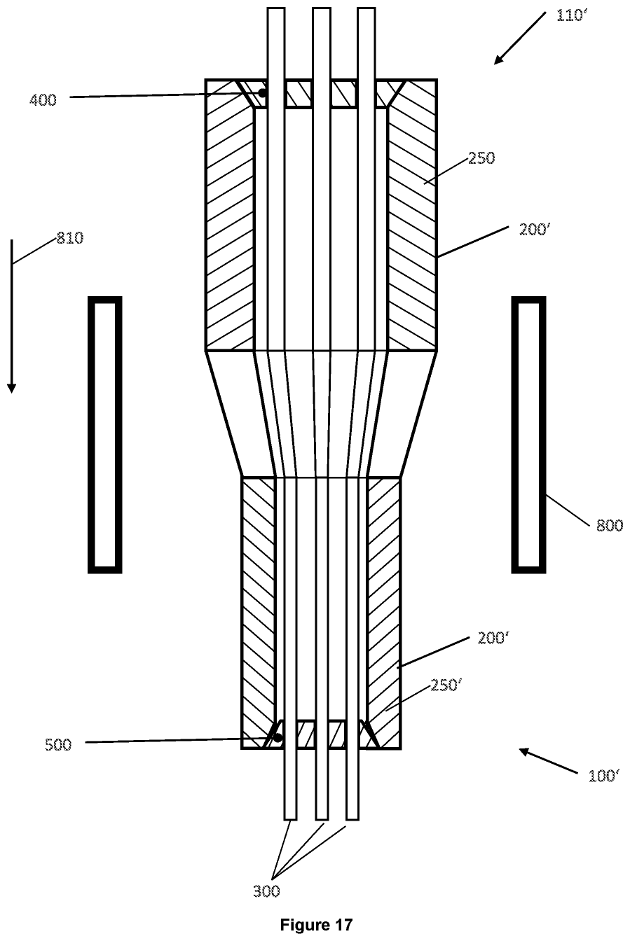

The assembly 110′″ shown in FIG. 16 for a preform corresponds to the assembly 100″ for a preform 100″ shown in FIG. 9. The two embodiments only differ in that the assembly 110′″ shown in FIG. 16 has a third positioning template 600′, which is designed so as to structurally correspond to FIG. 15. The positioning template 400″ prevents a longitudinal movement of the anti-resonance element preforms 300. The latter are positioned transversely through the receiving regions 430, which are designed in a tubular manner, and are positioned longitudinally through the holding regions 434. This prevents a deviation of the anti-resonance element preforms 300 from the target position.

As specified, a fixing of the anti-resonance element preforms 300 takes place on both front surfaces of the cladding tube 200 in known methods. This takes place via pointwise melting by means of a manual torch. Soot or burn-off, which deposits on the glass surfaces and which thus leads to a reduction of the quality of the preform, is created thereby. To overcome this disadvantage, an embodiment of the method described here is characterized in that the anti-resonance element preforms 300 are thermally fixed in a flame-free manner to the cladding tube wall 210 in step f) “processing” 1500.

FIG. 17 shows the creation of the preform 100′ shown in FIG. 8 as part of step f) “preparing” 1500. The movement arrow 810 clarifies the direction, from which the assembly 110′ is moved into an electric furnace 800—a flame-free heat source—so that the preform 100′ is created.

The illustrated assembly 110′ comprises the cladding tube 200′. The positioning template 400 and the second positioning template 500 are shaped in a truncated cone-like manner. The centering surface 420 and the second centering surface 520 are thereby partially formed in a cladding surface-like manner. The cladding tube 200 and the positioning template 400 as well as the second positioning template 500 are therefore designed in such a way that this can in each case cooperate in a positive manner. The elements are combined to form the assembly 110′ as part of steps of:
attaching the positioning template 400 to a first end 250 of the cladding tube 200′,
combining the second positioning template 500 with the second end 160 of the cladding tube 200′,
inserting at least parts of the anti-resonance element preforms 300 through the passage openings 410 for arranging the anti-resonance element preforms in the cladding tube inner bore, and
inserting at least parts of the anti-resonance element preforms 300 through the second passage openings 510 of the second positioning template 500.

An electric furnace 800 is listed in FIG. 17 as flame-free heat source. In the hot zone of the furnace, the assembly is heated to a temperature, at which the quartz glass becomes significantly more low-viscous there and permits a deformation. At the same time, one of the two work heads, into which the assembly is clamped, is displaced, so that the cladding tube 200 tapers to a thinner cross section and is collapsed thereby. The connection between anti-resonance element preforms 300 and cladding tube 200 is created exactly at that location, where the tube is heated up and tapered, namely successively over the entire length due to the progress of the process.

Due to the use of an electric furnace 800, the manual torch process for fixing the anti-resonance element preforms 300 can be dispensed with. In the case of manual torch processes, there are problems with burn-off and soot formation, which are associated with the torch use. The condensation cannot be removed completely subsequently, so that the preliminary product is already further processed with contaminations. Inter alia, blistering, inclusions, and later fiber breakage can thus result during the drawing. When using the furnace, the mentioned problems are eliminated, so that a clean preform can be produced.

As part of step f) “processing” 1500, the anti-resonance element preform 300 can be held in the cladding tube inner bore 220 only by means of
the positioning template 400, 400′, 400″, or
the positioning template 400, 400′, 400″ and the second positioning template 500, or
the positioning template 400, 400′, 400″ and the third positioning template 600, 600′

and otherwise without a substance-to-substance bond.

One aspect of the method is that the exact joining of cladding tube 200 can take place directly in a processing plant (such as, for instance, a vertical glass lathe) and only one process step is thus necessary for assembly and stretching of the entire preform.

In FIG. 17, the shown anti-resonance element preforms 300 are held in the cladding tube inner bore 220 only by means of the positioning template 400, 400′, 400″ and the second positioning template 500, and otherwise without a substance-to-substance bond.

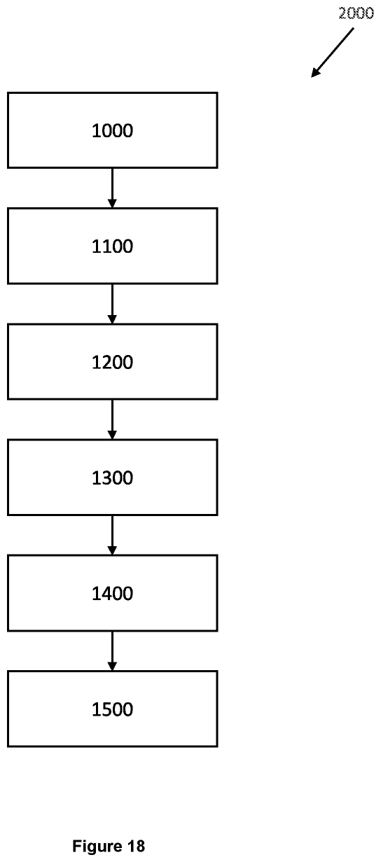

FIG. 18 shows an embodiment of a method 2000 for producing a preform 100 of an anti-resonant hollow-core fiber 2400, comprising the methods steps of
a) providing 1000 a cladding tube 200, which has a cladding tube inner bore 220 and a cladding tube longitudinal axis 230, along which a cladding tube wall 210 extends, which is limited by an inner side 215 and an outer side 216,
b) preparing 1100 a number of anti-resonance element preforms 300, each comprising an ARE outer tube 310 and an ARE inner tube 320 inserted therein,
c) preparing 1200 a positioning template 400, 400′, 400″, having a number of passage openings 410, 410′ passing through the positioning template 400, 400′, 400″, adapted for a longitudinal guidance of an anti-resonance element preform 300 each, wherein the positioning template 400, 400′, 400″ and the cladding tube 200 are made of identical material,
d) attaching 1300 the positioning template 400, 400′, 400″ to a first end 250 of the cladding tube 200,
e) inserting 1400 at least parts of the anti-resonance element preforms 300 through the passage openings 410, 410′ for arranging the anti-resonance element preforms in the cladding tube inner bore 220,
f) processing 1500 an assembly 110, comprising the cladding tube 200, the anti-resonance element preforms 300, and the positioning template 400, 400′, 400″ by means of a hot-forming process, selected from at least one of elongating and collapsing.

It is provided thereby that the method is designed in such a way that the positioning template 400, 400′, 400″ has at least one centering surface 420, which cooperates with the first end 250 of the cladding tube 200 in a self-centering manner in such a way that the anti-resonance element preforms 300 are arranged at target positions in step e) “inserting” 1400.

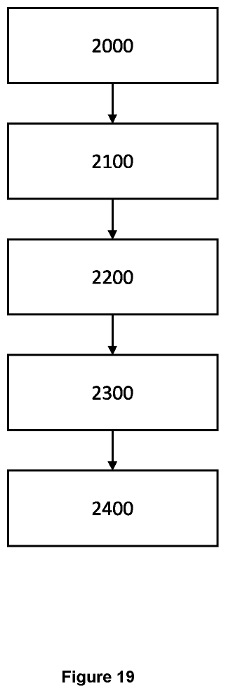

FIG. 19 shows an embodiment of a method for producing an anti-resonant hollow-core fiber 2400 from a preform 100, in particular produced according to any one of the preceding method steps 1000 to 1500, having the step of
further processing the preform 100 into the anti-resonant hollow-core fiber 2400,

wherein the further processing comprises a one-time or repeated performance of one or several of the following hot-forming processes:
collapsing 2100,
adding 2200 additional cladding material, and
elongating 2300.

All of the properties and features described for the passage openings also apply for the second passage openings and/or the third passage openings and vice versa.

All of the properties and features described for the positioning template also apply for the second positioning template and/or the third positioning template and vice versa.

All of the properties and features described for the method also apply for the preform and/or the anti-resonant hollow-core fiber and vice versa.

Unless otherwise specified, all of the physical variables specified in the claims, the description, and in the figures, are determined under normal conditions in accordance with DIN 1343. The statement “under normal conditions” refers to measurements under conditions in accordance with DIN 1343. The features disclosed in the claims, the description, and in the figures, can be significant for various designs of the claimed invention, both separately and in any combination with one another. The features disclosed for the devices, in particular preform, secondary preform, or anti-resonant hollow-core fiber, are also disclosed for the method and vice versa.

### REFERENCE NUMERALS

100, 100′, 100″ preform of an anti-resonant hollow-core fiber
110, 110′, 110″, 110′″ assembly
200, 200′ cladding tube
210 cladding tube wall
211 thickness of the cladding tube wall
215 inner side of the cladding tube wall
216 outer side of the cladding tube wall
220 cladding tube inner bore
230 cladding tube longitudinal axis
250 first end of the cladding tube
251 counter centering surface
260 second end of the cladding tube
261 second counter centering surface
300 anti-resonance element preform
400, 400′, 400″ positioning template
410, 410′ passage opening
420, 420′ centering surface
422 collar region
430 receiving region
432 transition region
434 holding region
500 second positioning template
510 second passage opening
520 second centering surface
600, 600′ third positioning template
610, 610′ third passage opening
620 third centering surface
700 closing element
710 active surface
730 first end region
740 second end region
750 outlet
800 heat source
810 movement arrow
900 first connecting element
910 second connecting element
1000 providing a cladding tube
1100 preparing a number of anti-resonance element preforms
1200 preparing a positioning template
1300 attaching
1400 inserting
1500 processing
2000 method steps 1000 to 1500
2100 collapsing
2200 adding additional cladding material
2300 elongating
2400 anti-resonant hollow-core fiber
2410 anti-resonance element
2420 ARE outer tube of the fiber
2430 ARE inner tube of the fiber
2450 cladding of the anti-resonant hollow-core fiber
2452 portion of the former cladding material at the cladding of the anti-resonant hollow-core fiber
2460 longitudinal axis of the anti-resonant hollow-core fiber
2470 hollow core of the anti-resonant hollow-core fiber
2480 inner surface

1. A method for producing a preform of an anti-resonant hollow-core fiber, comprising the steps of
a) providing a cladding tube, which has a cladding tube inner bore and a cladding tube longitudinal axis, along which a cladding tube wall extends, which is limited by an inner side and an outer side,
b) preparing a number of anti-resonance element preforms, each comprising an ARE outer tube and an ARE inner tube inserted therein,
c) preparing a positioning template, having a number of passage openings passing through the positioning template, adapted for a longitudinal guidance of an anti-resonance element preform each, wherein the positioning template and the cladding tube are made of identical material,
d) attaching the positioning template to a first end of the cladding tube,
e) inserting at least parts of the anti-resonance element preforms through the passage openings for arranging the anti-resonance element preforms in the cladding tube inner bore,
f) processing an assembly, comprising the cladding tube, the anti-resonance element preforms, and the positioning template, by means of a hot-forming process, selected from at least one of elongating and collapsing,
wherein
the positioning template has at least one centering surface, which cooperates with the first end of the cladding tube in a self-centering manner in such a way that the anti-resonance element preforms are arranged at target positions in step e) “inserting”.

2. The method according to claim 1, wherein the cladding tube is at least partially cut out in the region of the first end in order to form a counter centering surface), which cooperates with the centering surface in a positive manner.

3. The method according to claim 1, wherein the anti-resonance element preforms are thermally fixed in a flame-free manner to the cladding tube wall in step f) “processing”.

4. The method according to claim 1, wherein the cladding tube has a second end.

5. The method according to claim 4, wherein the method comprises the steps of:
(i) creating a second positioning template, having a number of second passage openings passing through the second positioning template, adapted for a longitudinal guidance of an anti-resonance element preform each, wherein the second positioning template and the cladding tube are made of identical material,
(ii) combining the second positioning template with the second end of the cladding tube.

6. The method according to claim 5, wherein the method comprises the steps of
(iii) inserting at least parts of the anti-resonance element preforms through the second passage openings of the second positioning template,
(iv) wherein the second positioning template has at least one second centering surface, which cooperates with the second end of the cladding tube in a self-centering manner in such a way that the anti-resonance element preforms are arranged at target positions in step (iii) “inserting”.

7. The method according to claim 6, wherein the cladding tube is at least partially cut out in the region of the second end in order to form a second counter centering surface, which cooperates with the second centering surface in a positive manner.

8. The method according to claim 1, wherein the method comprises the step of:
A/ preparing a third positioning template, having a number of third passage openings passing through the third positioning template, adapted for a longitudinal guidance of an anti-resonance element preform each,
wherein the third positioning template has at least one third centering surface.

9. The method according to claim 8, wherein the method comprises the step of:
B/producing a tubular closing element,
wherein the closing element has an active surface in the region of a first end region in order to cooperate with the third centering surface, in particular to cooperate in a positive manner.

10. The method according to claim 9, wherein the method comprises the steps of:
C/ linking the third positioning template to the first end region,
D/ connecting the closing element to the second end of the cladding tube,
E/ pushing at least parts of the anti-resonance element preforms through the third passage openings in order to arrange the anti-resonance element preforms in the cladding tube inner bore, wherein the third centering surface cooperates with the active surface in a self-centering manner in such a way that the anti-resonance element preforms are arranged at target positions.

11. The method according to claim 1, wherein at least one of the following steps comprises a flame-free thermal connecting or a flame-based thermal connecting:
step b) “preparing”,
step d) “attaching”,
step (ii) “combining”,
step C/ “linking”, and
step D/ “connecting”.

12. The method according to claim 1, wherein prior to step f) “processing”, the anti-resonance element preforms are only held by means of
the positioning template, or
the positioning template and the second positioning template, or
the positioning template and the third positioning template
and otherwise without a substance-to-substance bond in the cladding tube inner bore.

13. The method according to claim 1, wherein the positioning template and/or the second positioning template and/or the third positioning template has at least one gas flow element, which connects the cladding tube inner bore to the surrounding area of the preform in a fluid-conducting manner.

14. A method for producing a secondary preform, from which an anti-resonant hollow-core fiber can be drawn, from a preform, produced according to claim 1, having the step of
further processing the preform into the secondary preform,
wherein the further processing comprises a one-time or repeated performance of one or several of the following hot-forming processes:
vii.) elongating,
viii.) collapsing,
ix.) collapsing and simultaneous elongating,
x.) adding additional cladding material,
xi.) adding additional cladding material and subsequent elongating,
xii.) adding additional cladding material and simultaneous elongating.

15. A method for producing an anti-resonant hollow-core fiber from a preform, produced according to claim 1, having the step of
further processing the preform into the anti-resonant hollow-core fiber,
wherein the further processing comprises a one-time or repeated performance of one or several of the following hot-forming processes:
vii.) elongating,
viii.) collapsing,
ix.) collapsing and simultaneous elongating,
x.) adding additional cladding material,
xi.) adding additional cladding material and subsequent elongating,
xii.) adding additional cladding material and simultaneous elongating.
